(19) United States
(12) Patent Application Publication
(10) Pub. No.: US 2026/0261321 A1
(43) Pub. Date: Sep. 3, 2026

(54) BI-STATIC SENSING BEAM PAIRING IN INTEGRATED SENSING AND COMMUNICATION SYSTEMS

(71) Applicant: QUALCOMM Incorporated, San Diego, CA (US)

(72) Inventors: Mingxi YIN, Beijing (CN); Min HUANG, Beijing (CN); Jing DAI, Beijing (CN); Chao WEI, Beijing (CN); Hao XU, Beijing (CN)

(21) Appl. No.: 18/881,663

(22) PCT Filed: Sep. 10, 2022
(86) PCT No.: PCT/CN2022/118280

§ 371 Date: Jan. 6, 2025

(51) Int. Cl. H04B 7/06; H04B 17/318

(52) U.S. Cl. CPC H04B 7/06952; H04B 17/328

(57) ABSTRACT

Aspects presented herein may improve the performance of ISAC systems by enabling a receiving entity to constrain its Rx beam sweeping in certain beam direction(s) and/or gain(s) during bi-static/multi-static RF sensing. In one aspect, an apparatus configures the receiving entity to perform Rx beam sweeping constrained based on at least one of a Tx beam direction, a Tx power, a Tx beam gain, or a Tx beam pathloss of Tx beams from a transmitting entity or based on a predicted position of a target. The apparatus performs the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

### TECHNICAL FIELD

The present disclosure relates generally to communication systems, and more particularly, to positioning systems involving radio frequency (RF) sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus configures the receiving entity to perform receive (Rx) beam sweeping constrained based on at least one of a transmit (Tx) beam direction, a Tx power, a Tx beam gain, or a Tx beam pathloss of Tx beams from a transmitting entity or based on a predicted position of a target. The apparatus performs the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of radar signals (e.g., radar reference signals (RRSs)) generated from a wireless device in accordance with various aspects of the present disclosure.

FIG. 6 is a diagram illustrating an example of shared components for integrated sensing and communication (ISAC) in accordance with various aspects of the present disclosure.

FIG. 7A is a diagram illustrating an example co-located and cooperative radar and communication system in accordance with various aspects of the present disclosure.

FIG. 7B is a diagram illustrating an example co-design of communication and radar system in accordance with various aspects of the present disclosure.

FIG. 8A is a diagram illustrating an example mono-static sensing mode in accordance with various aspects of the present disclosure.

FIG. 8B is a diagram illustrating an example bi-static/multi-static sensing mode in accordance with various aspects of the present disclosure.

FIG. 9 is a diagram illustrating an example bi-static sensing radar geometry in accordance with various aspects of the present disclosure.

FIG. 10 is a diagram illustrating an example sensing beam sweeping for bi-static/multi-static sensing in accordance with various aspects of the present disclosure.

FIG. 11 is a diagram illustrating an example of useful and less useful reception (Rx) beams in accordance with various aspects of the present disclosure.

FIG. 12A is a diagram illustrating an example of a receiver constraining Rx beam directions for a given transmission (Tx) beam based on the transmission range of the Tx beam in accordance with various aspects of the present disclosure.

FIG. 12B is a diagram illustrating an example of a receiver constraining Rx beam directions for a given Tx beam based on the transmission range of the Tx beam in accordance with various aspects of the present disclosure.

FIG. 13 is a diagram illustrating an example of a receiver constraining Rx beam directions for a given Tx beam based on reference signal received power (RSRP) of the Tx beam in accordance with various aspects of the present disclosure.

FIG. 14 is a diagram illustrating an example of a receiver constraining Rx beam directions for a given Tx beam based on RSRP of the Tx beam in accordance with various aspects of the present disclosure.

FIG. 15 is a diagram illustrating an example of a receiver constraining Rx beam directions based on a predicted target position in accordance with various aspects of the present disclosure.

FIG. 16 is a diagram illustrating an example of a receiver constraining Rx beam gains based on Tx beams of a transmitter in accordance with various aspects of the present disclosure.

FIG. 17 is a diagram illustrating an example of a receiver constraining Rx beam directions/gains based on zones in accordance with various aspects of the present disclosure.

FIG. 18 is a flowchart of a method of wireless communication.

FIG. 19 is a flowchart of a method of wireless communication.

FIG. 20 is a diagram illustrating an example of a hardware implementation for an example apparatus and/or network entity.

FIG. 21 is a diagram illustrating an example of a hardware implementation for an example apparatus and/or network entity.

FIG. 22 is a diagram illustrating an example of a hardware implementation for an example apparatus and/or network entity.

### DETAILED DESCRIPTION

Aspects presented herein may improve the efficiency and time for bi-static/multi-static sensing. Aspects presented herein may provide better radio resource usage and power saving for devices performing RF sensing, and improve sensing accuracy by enabling beam pair power control. For example, aspects presented herein may enable a receiver to constrain its beam sweeping in certain directions and/or using certain power parameters based on Tx beam(s) of a transmitter to save beam, radio resource, and/or power for the beam sweeping during bi-static sensing.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

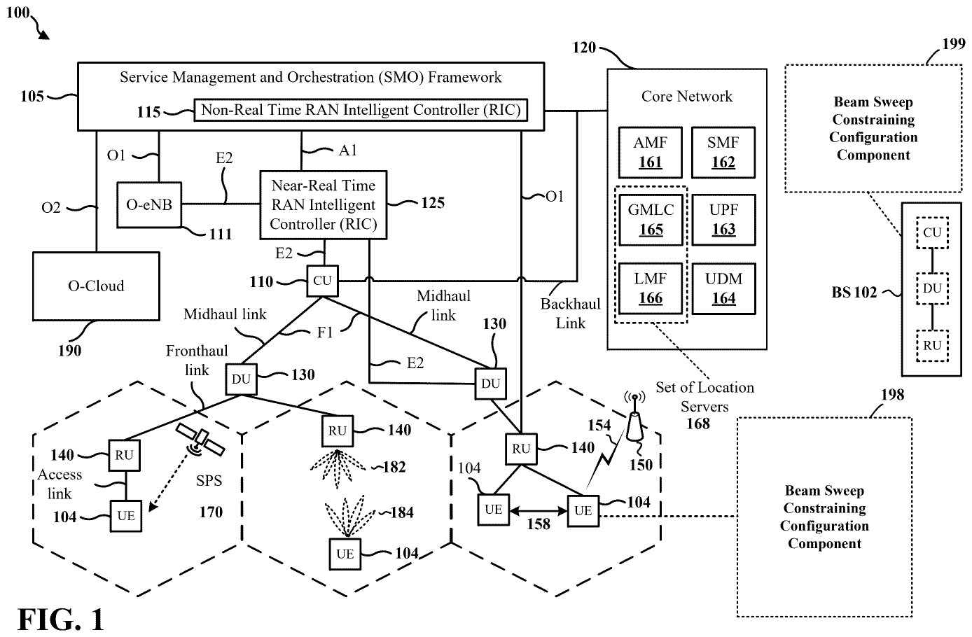

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to configure the receiving entity to perform Rx beam sweeping constrained based on at least one of a Tx beam direction, a Tx power, a Tx beam gain, or a Tx beam pathloss of Tx beams from a transmitting entity or based on a predicted position of a target; and perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target via the beam sweep constraining configuration component 198. In certain aspects, the base station 102 may be configured to configure the receiving entity to perform Rx beam sweeping constrained based on at least one of a Tx beam direction, a Tx power, a Tx beam gain, or a Tx beam pathloss of Tx beams from a transmitting entity or based on a predicted position of a target; and perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target via the beam sweep constraining configuration component 199.

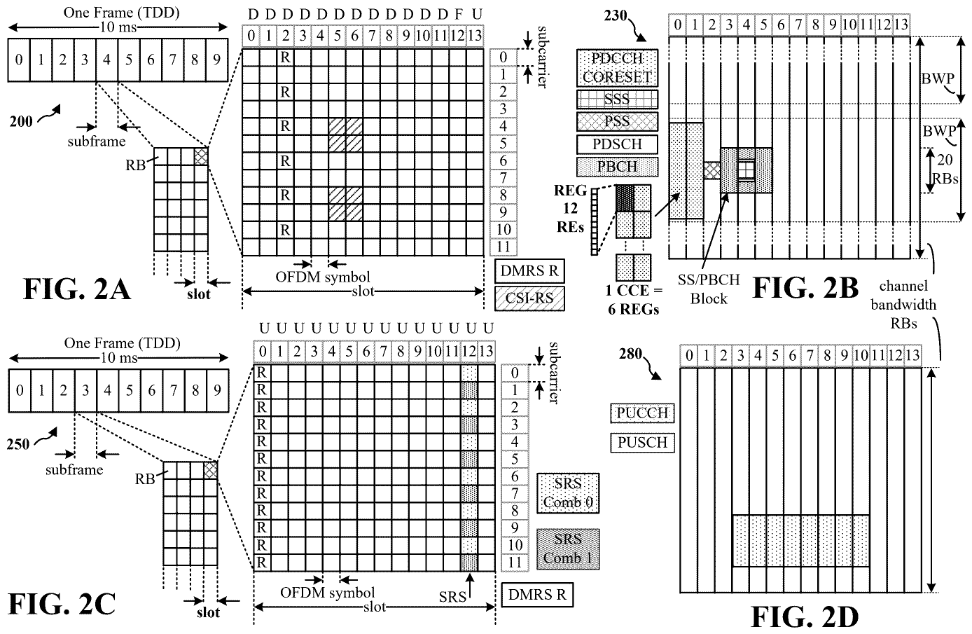

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

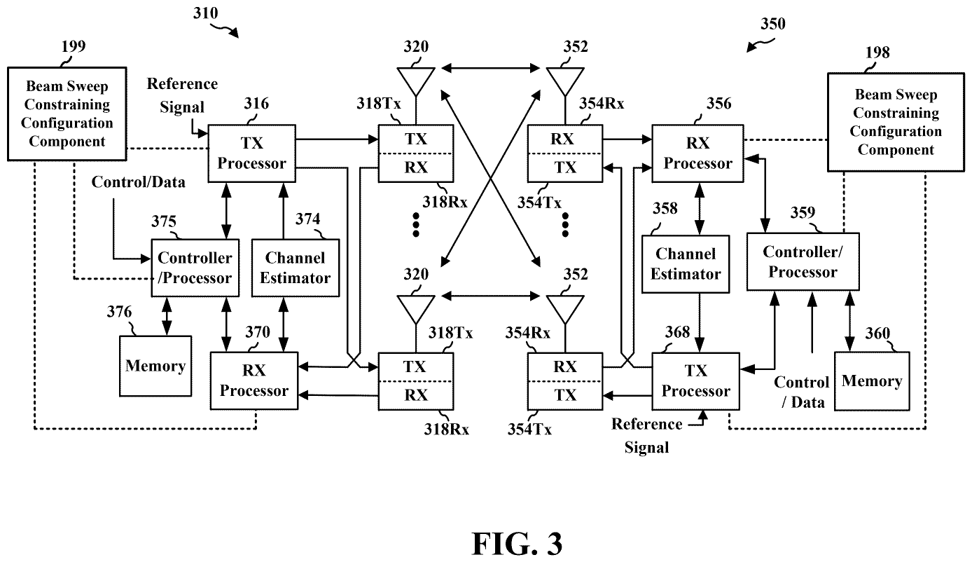

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the beam sweep constraining configuration component 198 of FIG. 1.

At least one of the TX processor 316, the RX processor 370, and the controller/processor 375 may be configured to perform aspects in connection with the beam sweep constraining configuration component 199 of FIG. 1.

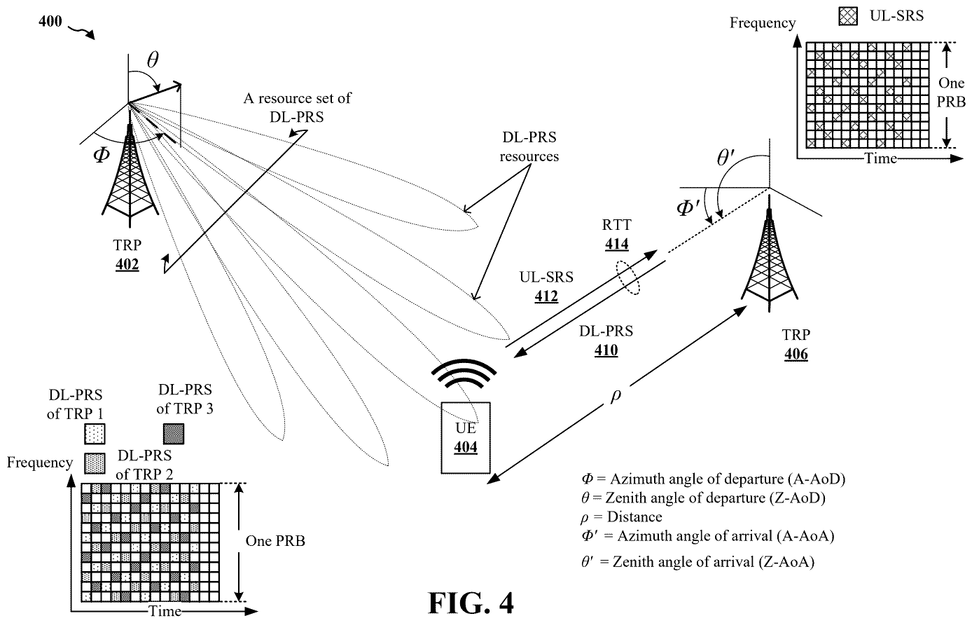

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}∥−∥T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a base station, a component of the base station, a UE, etc.) may also be configured to include radar capabilities, which may be referred to as “radio frequency (RF) sensing” and/or “cellular-based RF sensing.” For example, a wireless device may transmit radar reference signals (RRSs) and measure the RRSs reflected from one or more objects. Based at least in part on the measurement, the wireless device may determine or estimate a distance between the wireless device and the one or more objects. In another example, a first wireless device may also receive RRSs transmitted from a second wireless device, where the first wireless device may determine or estimate a distance between the first wireless device and the second wireless device based at least in part on the received RRS. As such, in some examples, RF sensing techniques may be used for UE positioning and/or for assisting UE positioning. For purposes of the present disclosure, a device that is capable of performing RF sensing (e.g., transmitting and/or receiving RRS for detecting an object or for estimating the distance between the device and the object) may be referred to as an “RF sensing node.” For example, an RF sensing node may be a UE, a base station, a component of the base station, a TRP, a device capable of transmitting RRS, and/or a device configured to perform radar functions, etc.

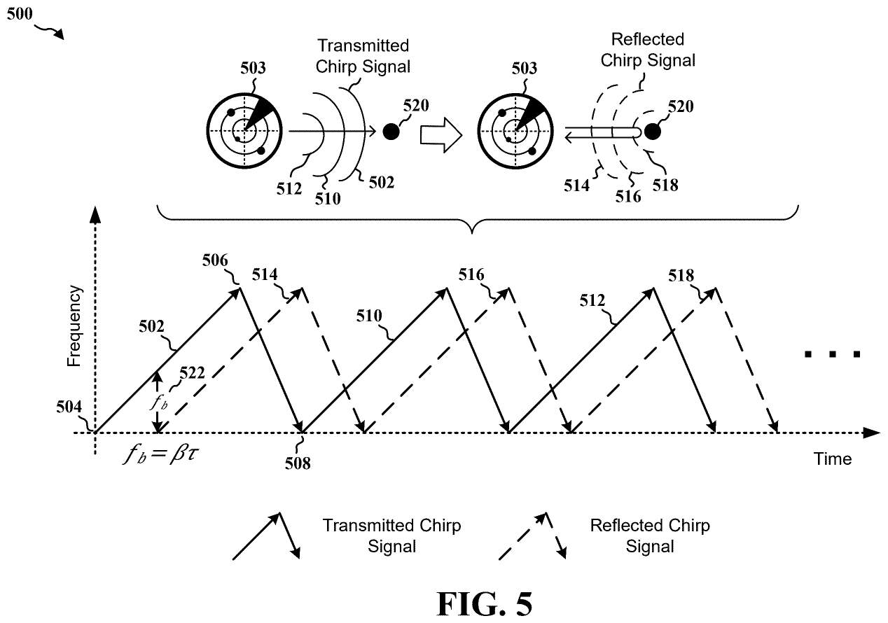

FIG. 5 is a diagram 500 illustrating an example radar signal (e.g., RRS) generated from an RF sensing node in accordance with various aspects of the present disclosure. An RF sensing node 503 may detect an object 520 (e.g., the location, the distance, and/or the speed of the object 520 with respect to the RF sensing node 503) by transmitting RRS towards the object 520 and receiving the RRS reflected (e.g., bounce off) from the object 520. In some examples, the object 520 may be a radar receiver or have a capability to receive and process RRS.

In one example, the RRS may be a chirp signal that includes a frequency that varies linearly (e.g., has a frequency sweeping) over a fixed period of time (e.g., over a sweep time) by a modulating signal. For example, as shown by the diagram 500, a transmitted chirp signal 502 may have a starting frequency at 504 of a sinusoid. Then, the frequency may gradually (e.g., linearly) increase on the sinusoid until it reaches an ending (or highest) frequency at 506 of the sinusoid, and then the frequency of the signal may return to the starting frequency as shown at 508 and another chirp signal 510 may be transmitted in the same way. In other words, each chirp signal may include an increase in frequency (e.g., linearly) and a drop in frequency or vice versa (e.g., including a decrease in frequency and then an increase in frequency), such that the RF sensing node 503 may transmit chirp signals sweeping in frequency. In some examples, such chirp signal may also be referred to as a frequency modulated continuous wave (FMCW).

After a chirp signal (e.g., chirp signal 502, 510, 512, etc.) is transmitted by the RF sensing node 503, the transmitted chirp signal may reach the object 520 and reflect back to the RF sensing node 503, such as shown by the reflected chirp signals 514, 516, and 518, which may correspond to the transmitted chirp signals 502, 510, and 512, respectively. As there may be a distance between the RF sensing node 503 and the object 520 and/or it may take time for a transmitted chirp signal to reach the object 520 and reflect back to the RF sensing node 503, a delay may exist between a transmitted chirp signal and its corresponding reflected chirp signal. As the delay may be proportional to a range between the RF sensing node 503 and the object 520 (e.g., the further the target, the larger the delay and vice versa), the RF sensing node 503 may be able to measure or estimate a distance between the RF sensing node 503 and the object 520 based on the delay.

In some examples, the RF sensing node 503 may also measure a difference in frequency between the transmitted chirp signal and the reflected chirp signal, which may also be proportional to the distance between the RF sensing node 503 and the object 520. In other words, as the frequency difference between the reflected chirp signal and the transmitted chirp signal increases with the delay, and the delay is linearly proportional to the range, the distance of the object 520 from the RF sensing node 503 may also be determined based on the difference in frequency. Thus, the reflected chirp signal from the object 520 may be mixed with the transmitted chirp signal and down-converted to produce a beat signal (f_{b}) which may be linearly proportional to the range after demodulation. For example, the RF sensing node 503 may determine a beat signal 522 by mixing the transmitted chirp signal 502 and its corresponding reflected chirp signal 514. While examples in the diagram illustrate using an FMCW waveform for the RRS, other types of radar waveforms may also be used by the RF sensing node 503 for the RRS.

Due to an increased amount of bandwidth (BW) being allocated for cellular communications systems (e.g., 5G and beyond) and an increased amount of applications (e.g., use cases) being introduced with cellular communications systems, joint communication and RF sensing, which may also be referred to as integrated sensing and communication (ISAC) and/or joint communication-radar (JCR), may become an important feature for cellular systems. For example, a wireless device (e.g., a base station, a component of a base station, a UE, a component of a UE, an RF sensing node, etc.) may be configured to transmit communication signals (e.g., PDSCH, PUSCH, PSSCH, etc.) with radar signals (e.g., RRS, FMCW signals, etc.) together or close in time (e.g., based on TDM, FDM, SDM, etc.). In addition, OFDM waveform (or its variants) may be used as the waveform for the ISAC/JCR as the OFDM waveform may enable in-band multiplexing with other cellular reference signals and physical channels. As such, the radar signals may be multiplexed with communication signals based on OFDM waveform. For purposes of the present disclosure, a wireless device that performs an RF sensing based on OFDM waveform(s) or transmits RRS based on OFDM waveform(s) may be referred to as an “OFDM radar.”

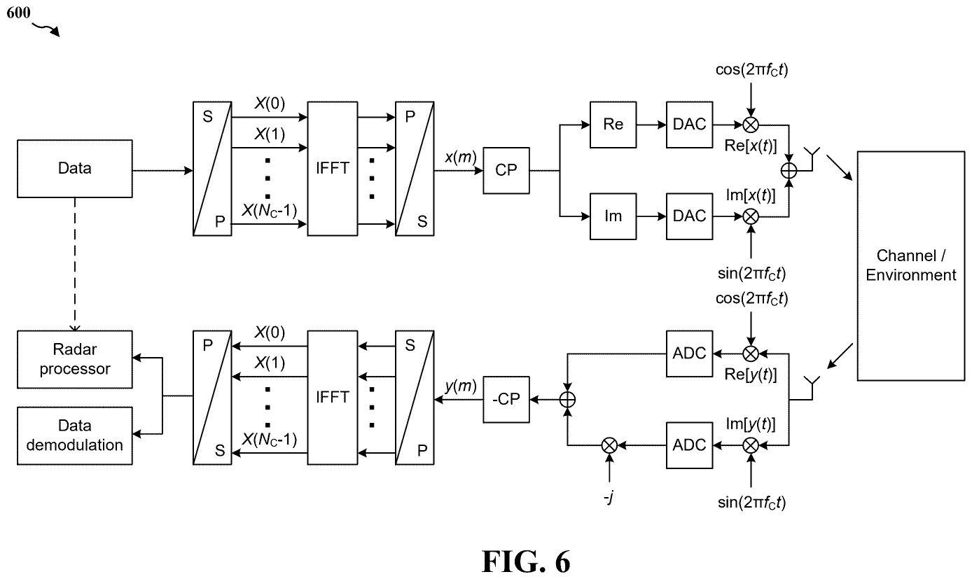

FIG. 6 is a diagram 600 illustrating an example of shared components for ISAC in accordance with various aspects of the present disclosure. A wireless device may be configured to share its RF (and possibly baseband) hardware components and frequency band for both sensing and communication to provide a cost and spectrum effective design. In some examples, ISAC may be used for macro sensing, such as meteorological monitoring, autonomous driving, dynamic map, low-altitude airspace (e.g., unmanned aerial vehicle (UAV)) management, and intruder detection, etc. In other examples, ISAC may be used for micro sensing, such as gesture recognition, vital signal detection, and high-resolution imaging with THz, etc. In addition, ISAC may also provide sensing assisted communication, where information obtained via sensing (e.g., whether there are obstacles in certain directions) may be used for improving the communication, such as for beam management.

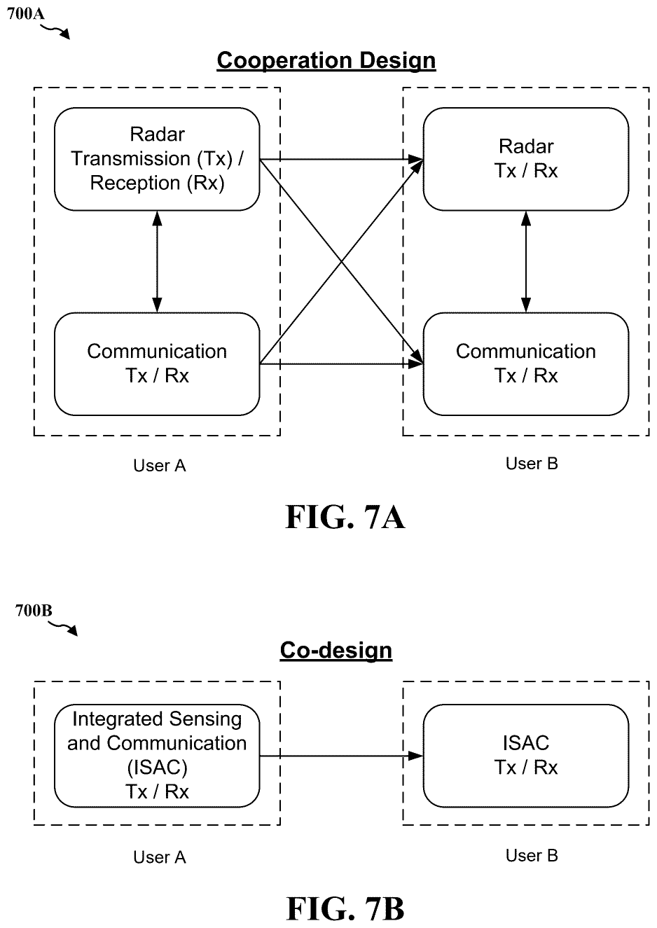

In some implementations, ISAC systems may be categorized as co-located and cooperative radar and communication systems and co-design of communication and radar systems. FIG. 7A is a diagram 700A illustrating an example co-located and cooperative radar and communication system in accordance with various aspects of the present disclosure. For this type of ISAC system, some knowledge (e.g., transmission information/configuration) is shared between the communication aspect and radar aspect of the system to improve the system's performance, without much altering the core operation of the radar and communication system. For example, as shown by the diagram 700A, each of the devices used by a first user (user A) and a second user (user B) may include a radar transmission (Tx)/reception (Rx) component that is capable of transmitting/receiving radar reference signals (RRSs) and a communication Tx/Rx component that is capable of transmitting/receiving communication signals. The radar Tx/Rx component and the communication Tx/Rx component may communicate with each to coordinate the transmission of radar signals and communication signals to other devices and/or the reception of radar signals and communication signals from other devices.

FIG. 7B is a diagram 700B illustrating an example co-design of communication and radar system in accordance with various aspects of the present disclosure. For this type of ISAC system, as shown by the diagram 700B, a common transmitter or receiver is used for both communication and radar functionalities. This type of system may specify certain amount of modifications in the transmitting waveform generation or the receiver processing of both or either of the radar and communication systems. This type of ISAC system design may provide an improved hardware and spectrum reuse. Communication-centric ISAC that exploits a single communication transmission hardware may be favored by some network implementation because it may support both high-data rate communication and high-resolution sensing. For example, as described above, OFDM-based waveform may be used by the radar system for sensing purpose while remaining compatible with OFDM-based communication system.

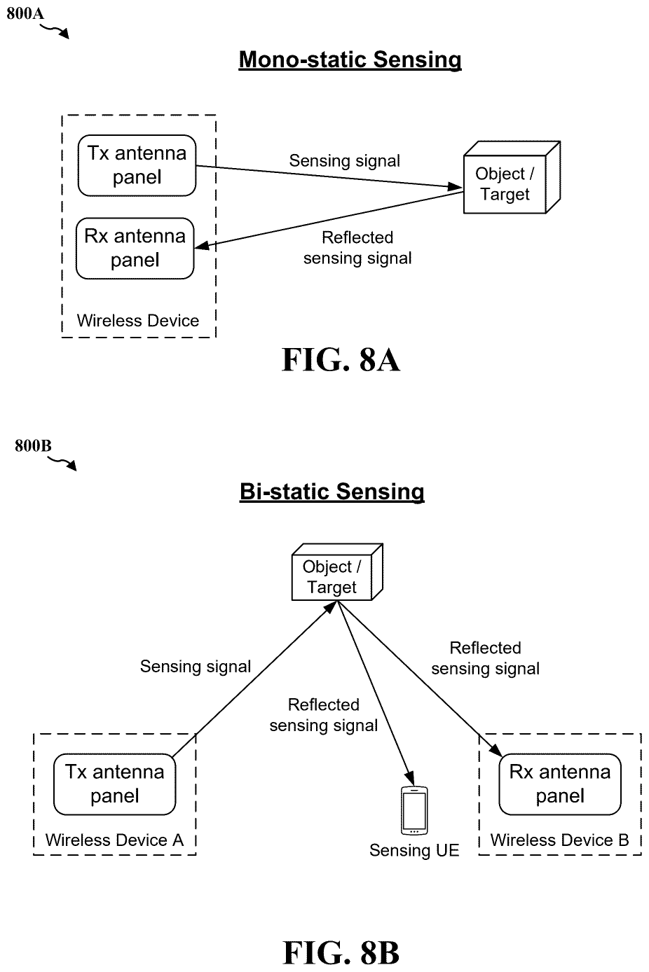

In some implantations, RF sensing may be categorized in two types of RF sensing mode: a mono-static sensing mode and a bi-static/multi-static sensing mode (which may also be referred to as “mono-static RF sensing” and “bi-static RF sensing” respectively). FIG. 8A is a diagram 800A illustrating an example mono-static sensing mode in accordance with various aspects of the present disclosure. Under mono-static sensing, the transmitter (e.g., the Tx antenna panel) and the receiver (e.g., the Rx antenna panel) of the RF sensor are co-located, such as in the same wireless device (e.g., a base station, a component of a base station, a UE, a component of a UE, etc.). Thus, the transmission and reception of the radar signals may be performed by one device. In other words, one radar/sensor is configured to both transmit sensing signals and receive reflected sensing signals. An advantage of mono-static sensing is that it may not specify Tx/Rx (transmitter/receiver) pairing/grouping. However, mono-static sensing may specify self-interference mitigation as the same wireless device is used for transmitting both sensing signals and communication signals.

FIG. 8B is a diagram 800B illustrating an example bi-static/multi-static sensing mode in accordance with various aspects of the present disclosure. Under bi-static/multi-static sensing, the transmitter and receiver may be separated (e.g., on different wireless devices and/or locations). For example, the transmitter (e.g., the Tx antenna panel) of a first wireless device may transmit sensing signals, and the sensing signals or sensing signals reflected from one or more objects may be received by the receiver (e.g., the Rx antenna panel) of a second wireless device (e.g., a sensing base station, a sensing UE, etc.). An advantage of bi-static/multi-static sensing is that it may not specify self-interference mitigation. However, bi-static/multi-static sensing may specify Tx/Rx (transmitter/receiver) pairing/grouping. However, mono-static sensing may specify self-interference mitigation as the same wireless device is used for transmitting both sensing signals and communication signals.

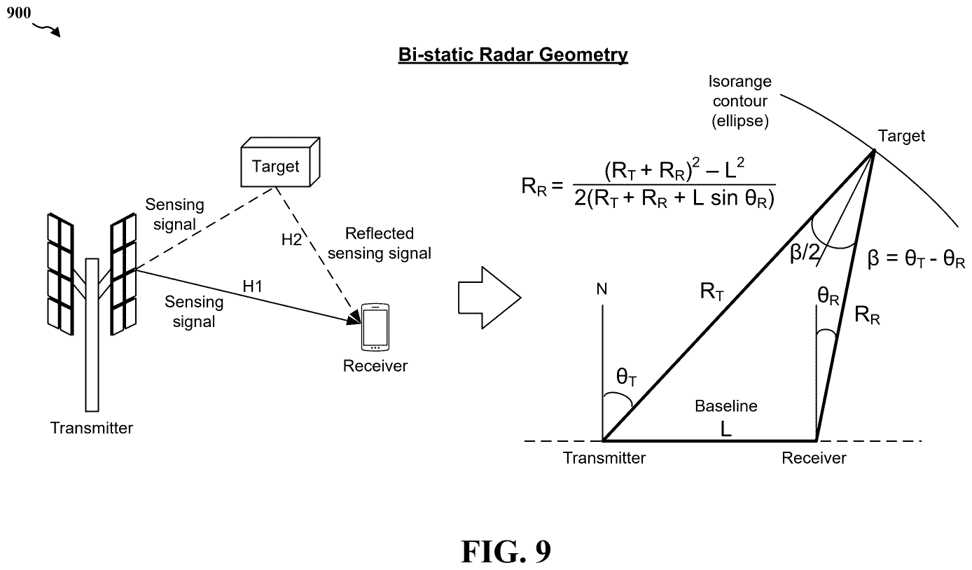

FIG. 9 is a diagram 900 illustrating an example bi-static sensing radar geometry in accordance with various aspects of the present disclosure. In one example, the setup for a bi-static sensing radar may be represented as a bi-static triangle. The transmitter (e.g., the Tx panel) and receiver (e.g., the Rx panel) are separated by a baseline L, R_{T} stands for range from the transmitter to a target, and R_{R} is the range from the receiver to the target. Bi-static angle β is formed at the target. There are three parameters for which the receiver may measure: the difference in range (R_{T}+R_{R}−L) between the direct sensing signal (e.g., H1) and the transmitter-target-receiver path (e.g., H2), the angle of arrival θ_{R} of the received reflected sensing signal, and the Doppler shift f_{D} of the received reflected sensing signal. If the distance L is known, bi-static range (R_{T}+R_{R}) may be extracted from the measured quantity (R_{T}+R_{R}−L). Hence, after measuring angle of arrival OR, range of the target from the receiver may be found based on: R_{R}=(R_{T}+R_{R})²−L²/²(R_{T}+R_{R}+Lₛᵢₙ θ_{R}).

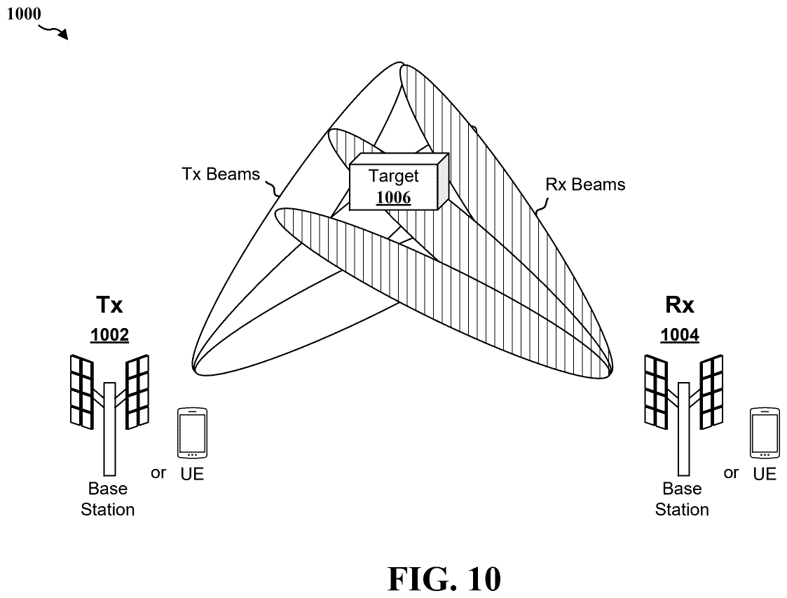

FIG. 10 is a diagram 1000 illustrating an example sensing beam sweeping for bi-static/multi-static sensing in accordance with various aspects of the present disclosure. To detect a target 1006, a transmitter 1002 (e.g., a first base station, a first UE, a Tx antenna panel, etc.) may measure the position and the velocity of the target 1006 based on performing beam sweeping with a receiver 1004 (e.g., a second base station, a second UE, an Rx antenna panel, etc.). For example, the position of the target 1006 may be determined based on the intersection of the Tx beam (of the transmitter 1002) and the Rx beam (of the receiver 1004) pair by which the target 1006 is detected. For another example, the position of the target 1006 may be determined based on the time-of-flight (ToF) of the signal transmitted by the Tx beam (of the transmitter 1002) and received by the Rx beam (of the receiver 1004). For another example, the position of the target 1006 may be determined based on the combination of the above two examples. The velocity of the target 1006 may be analyzed based on Doppler shift of the received signal in the Rx beam of the receiver 1004. In some examples, the transmitter 1002 may be configured to perform Tx beam sweeping in all directions from a certain set. Then, for one Tx beam during the sweeping, the receiver 1004 may also be configured to perform Rx beam sweeping in all directions from a certain set. Thus, if there are N Tx beams and M Rx beams in the certain sets, the total number of Tx and Rx beam pairs in the sweeping is NM. For example, if there three (3) Tx beams and five (5) Rx beams, then there is a total of fifteen (e.g., 3×5=15) Tx-Rx beam pairs. For purposes of the present disclosure, a “beam pair” may refer to a Tx beam at a transmitter and an Rx beam at a receiver. For example, if a transmitter is transmitting signal/data to a receiver using a Tx beam X and the receiver is receiving the signal/data using an Rx beam Y, the Tx beam X and the Rx beam Y may be referred to as a beam pair.

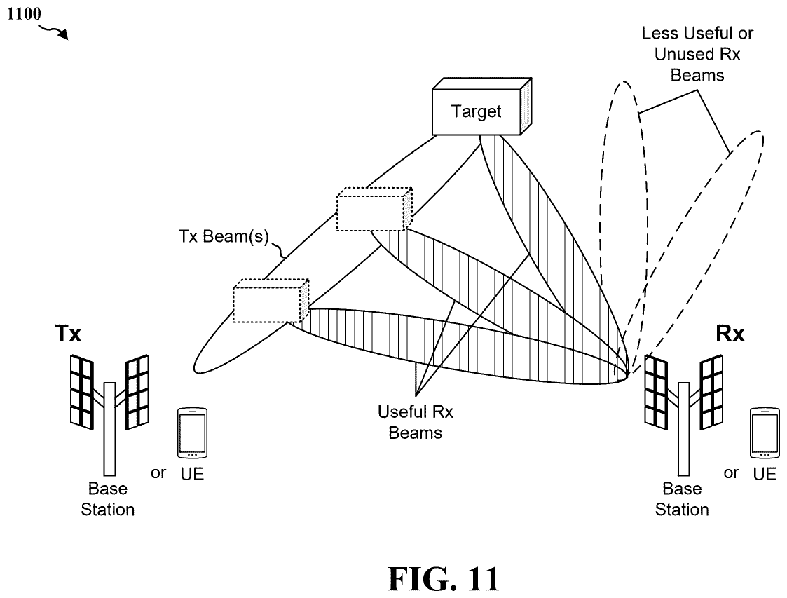

In some scenarios, as shown by a diagram 1100 of FIG. 11, for a given Tx beam, there may be just a group of Rx beam in certain directions that may be useful (e.g., providing useful information and measurements), and Rx beams in other directions may be unused or provide less useful information and measurements. As such, if the receiver is configured to perform the Rx beam sweeping in all directions of the set, there may be a waste of resources and/or receiver power, because some directions and intersection zones may be out of the coverage of the Tx beam.

Aspects presented herein may improve the efficiency and time for bi-static/multi-static sensing. Aspects presented herein may provide better radio resource usage and power saving for devices performing RF sensing, and improve sensing accuracy by enabling beam pair power control. For example, aspects presented herein may enable a receiver to constrain its beam sweeping in certain directions and/or using certain power parameters based on Tx beam(s) of a transmitter to save beam, radio resource, and/or power for the beam sweeping during bi-static sensing.

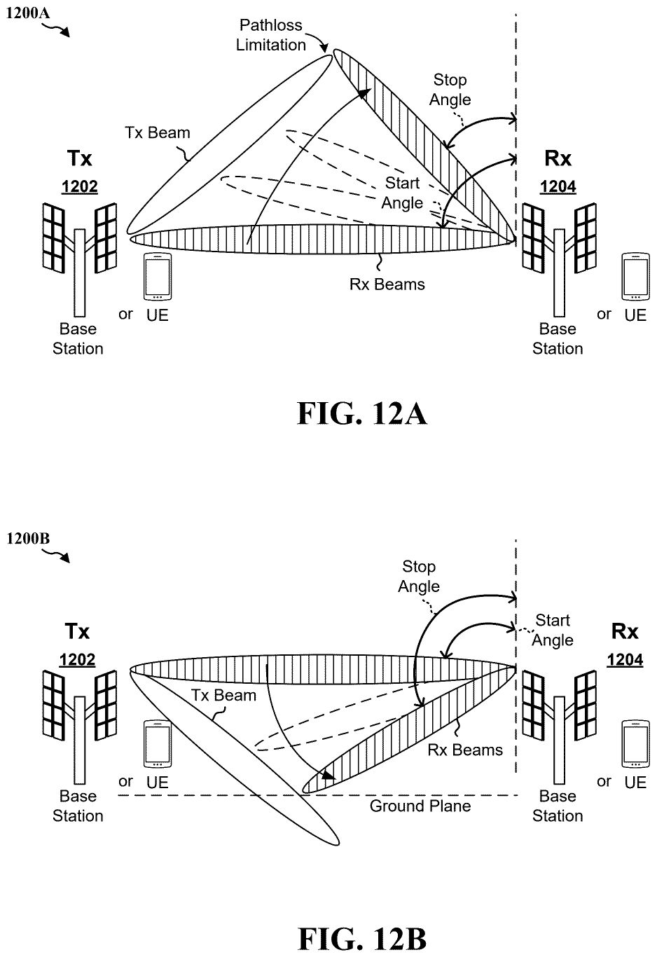

FIGS. 12A and 12B are diagrams 1200A and 1200B, respectively, illustrating examples of a receiver constraining Rx beam directions for a given Tx beam based on the transmission range of the Tx beam in accordance with various aspects of the present disclosure. A receiver 1204, which may be a first UE, a first base station, or a component of a first base station, etc., may be configured to constrain its Rx beam sweeping directions based on the Tx beam direction, the Tx power, and the pathloss of a Tx beam from a transmitter 1202, which may be a second UE, a second base station, or a component of a second base station, etc. Such configuration may reduce the Rx beam sweeping time and power for the receiver 1204.

In one aspect, the receiver 1204 may start an Rx beam sweeping at a start angle/direction and stop the Rx beam sweeping at a stop angle/direction based on a Tx beam of the transmitter 1202. For example, as shown by the diagram 1200A of FIG. 12A, the start angle/direction of the Rx beam sweeping may be toward the transmitter 1202 or towards the Tx antenna panel orientation of the transmitter 1202, and the stop angle/direction of the Rx beam sweeping may be the maximum transmission range of the Tx beam. In some examples, the maximum transmission range of the Tx beams may be based on the transmission power of the Tx beam, Tx beam gain, Tx antenna gain, Tx signal carrier frequency, wireless channel coefficients from the transmitting entity, or a combination thereof. In other examples, as shown by the diagram 1200B of FIG. 12B, the maximum transmission range of the Tx beam may further be limited by pathloss, obstacles, and/or the ground plane. During the Rx beam sweeping, the transmitter 1202 may transmit the same Tx beam periodically.

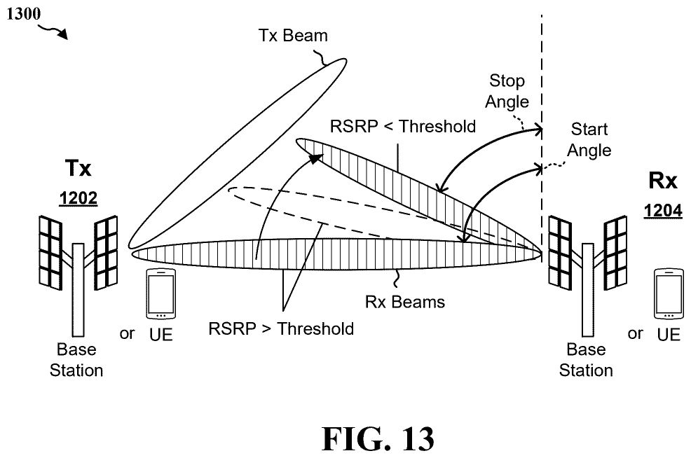

In another example, as shown by a diagram 1300 of FIG. 13, instead of configuring the stop angle/direction to be the maximum transmission range of the Tx beam, the receiver 1204, the receiver 1204 may determine the stop angle/direction based on a reference signal received power (RSRP) of the Tx beam less than an RSRP threshold. For example, the receiver 1204 may start the Rx beam sweeping at a start angle and measure the RSRP of a Tx beam. If the RSRP is above a threshold, the receiver my continue the Rx beam sweeping, such as move toward next beam step angle and perform the RSRP measurement. However, when the RSRP measured at the receiver 1204 keeps declining and is lower than the threshold, the receiver 1204 may stop the Rx beam sweeping. Similarly, during the Rx beam sweeping, the transmitter 1202 may transmit the same Tx beam periodically.

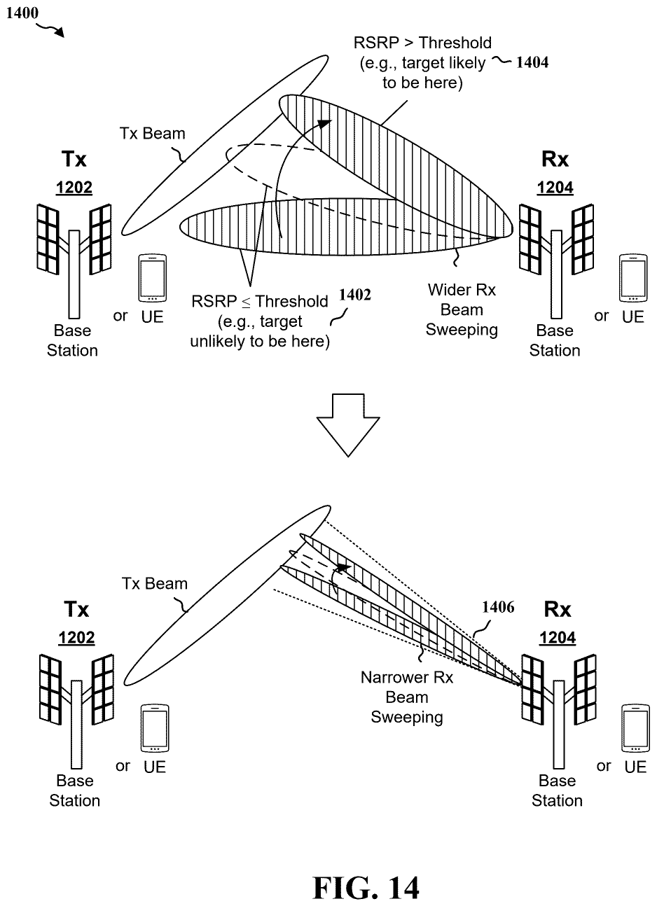

FIG. 14 is a diagram 1400 illustrating an example of a receiver constraining Rx beam directions for a given Tx beam based on RSRP of the Tx beam in accordance with various aspects of the present disclosure. In another example, to improve the efficiency and time for Rx beam sweeping, the receiver 1204 may be configured to start the Rx beam sweeping using wider Rx beams, and measure the RSRP of the Tx beam. As shown at 1402, if the RSRP at the receiver 1204 is lower than or equal to a threshold (e.g., RSRP≤threshold), the receiver 1204 may change/move the Rx beam for the Rx beam sweeping to the next step angle/direction and continue with the Rx beam sweeping using wider Rx beams. However, as shown at 1404, if the RSRP is larger than the threshold (e.g., RSRP >threshold), the receiver 1204 may changes the wider Rx beam to a narrower Rx beam, and continue to perform the Rx beam sweeping in the same direction (e.g., the direction of the wide beam with RSRP greater than the threshold) with a smaller step angle/direction, such as shown at 1406. In some examples, the threshold for moving on to the next step angle/direction or for changing to a narrower beam may be configured to be a variable that is depending on the Rx beam width. For example, as Rx beam width may be associated with the Rx beam gain, the Rx beam width may impact the RSRP measured at the receiver 1204. As such, higher threshold may be configured for narrower beams, and lower thresholds may be configured for wider beams, etc.

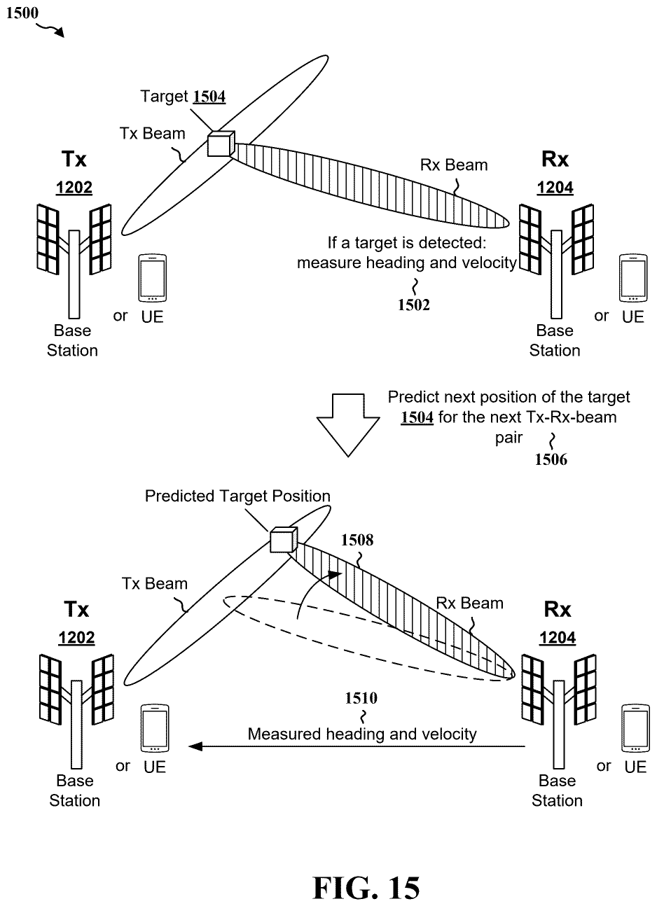

FIG. 15 is a diagram 1500 illustrating an example of a receiver constraining Rx beam directions based on a predicted target position in accordance with various aspects of the present disclosure. In another example, to improve the efficiency and time for Rx beam sweeping and/or Tx beam sweeping, the receiver 1204 may be configured to constrain the Rx beam direction based on a target's next predicted position. For example, as shown at 1502, if the receiver 1204 detects a target 1504 during the Rx beam sweeping, the receiver 1204 may measure at least the heading and the velocity of the target 1504. The receiver 1204 may be able to detect the target 1504 based on the RSRP, time of flight (ToF), Doppler shift, or a combination of thereof satisfying one or more thresholds. Then, as shown at 1506, the receiver 1204 may predict the next position of the target 1504 for the next Tx-Rx beam pair based on the measured heading and velocity of the target 1504. As shown at 1508, the receiver 1204 may constrain the Rx beam directions/angles toward the predicted position of the target 1504 to save radio resource and/or power at the receiver 1204.

In some example, as shown at 1510, the receiver 1204 may report the measured target heading and velocity to the transmitter 1202. Similarly, the transmitter 1202 may predict the position of the target 1504 based on the measured heading and velocity received from the receiver 1204, and the transmitter 1202 may also constrain the Tx beam directions/angles toward the predicted position of the target 1504 to save radio resource and/or power at the transmitter 1202. As such, both Tx and Rx beam directions/angles may be constrained by the measured target heading and velocity as both the transmitter 1202 and the receiver 1204 are able to predict the next position of the target 1504 with the target heading and velocity when the next Tx and Rx beam pair are used (e.g., the next Tx and Rx beams are configured to be directed toward the predicted target's next position).

In another example, for bi-static sensing, as the heading and velocity measurements may be the projection of the real heading and velocity in a certain direction, the predicted target's next position may be an area. As such, the transmitter 1202 and the receiver 1204 may perform the Tx and Rx beam sweeping, respectively, in the predicted area to conserve radio resource and/or power.

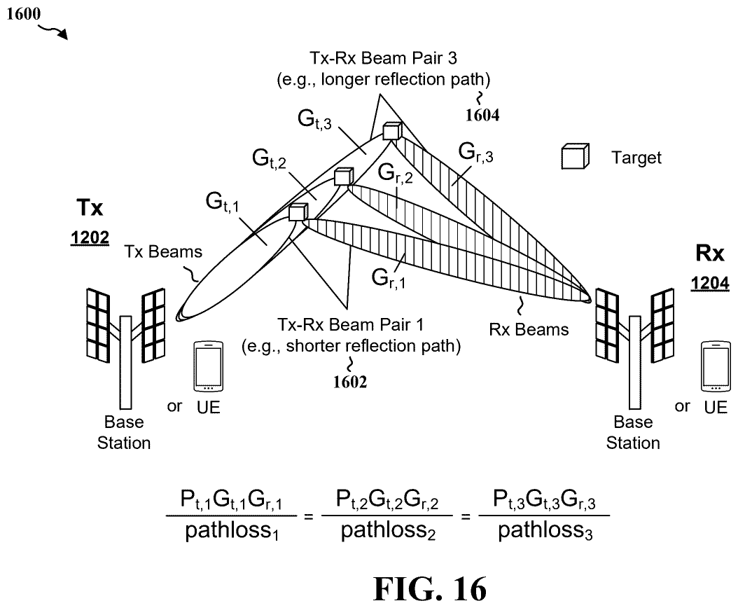

FIG. 16 is a diagram 1600 illustrating an example of a receiver constraining Rx beam gains based on Tx beams of a transmitter in accordance with various aspects of the present disclosure. In another aspect of the present disclosure, to save radio resource or power, the receiver 1204 may be configured to maintain a constant receive power for targets at different positions. The accuracy for the bi-static/multi-static sensing may also be improved by enhancing the analog-to-digital converter (ADC) utilization, such as letting the receive power mainly affected by a target's radar cross-section (RCS).

In one example, the beam gain at the transmitter 1202 and/or at the receiver 1204 may be dynamically adjusted based on the target, such that a constant receiver power may be maintained at the receiver 1204 for targets at different positions. For example, as shown at 1602, for a target that has a shorter reflection path, a lower beam gain may be used by the transmitter 1202 and/or the receiver 1204 for a beam pair (e.g., implemented by using a wider beam or lower transmit power, etc.), whereas as shown at 1604, for a target that has a longer reflection path, a higher beam gain may be used by the transmitter 1202 and/or the receiver 1204 for a beam pair (e.g., implemented by using a narrower beam or higher transmit power, etc.). In other words, the transmitter 1202 may vary the Tx transmit power (P_{t,i})/Tx gain (G_{t,i}) of a Tx beam i and/or the receiver 1204 may vary the Rx gain (G_{r,i}) of an Rx beam I of each beam pair to keep the receiver power constant, such that

$$\frac{{P}_{t , 1} {G}_{t , 1} {G}_{r , 1}}{{pathloss}_{1}} = \frac{{P}_{t , 2} {G}_{t , 2} {G}_{r , 2}}{{pathloss}_{2}} = \frac{{P}_{t , 3} {G}_{t , 3} {G}_{r , 3}}{{pathloss}_{3}}$$

and so on.

In one example, aspects discussed in connection with FIG. 16 may be implemented at the transmitter 1202 (and not at the receiver 1204), where the transmitter 1202 may vary the Tx transmit power (Pₜ) and/or the Tx beam gain (Gₜ) and the receiver 1204 may keep the Rx beam gain (Gᵣ) fixed to keep the receive power of a given beam pair constant. In another example, aspects discussed in connection with FIG. 16 may be implemented at the receiver 1204 (and not at the transmitter 1202), where the receiver 1204 may vary the Rx beam gain (Gᵣ) and the transmitter 1202 may keep the Tx transmit power (Pₜ) and/or the Tx beam gain (Gₜ) fixed to keep the receive power of a given beam pair constant. In another example, aspects discussed in connection with FIG. 16 may be implemented at both the transmitter 1202 and the receiver 1204, where the transmitter 1202 may vary the Tx transmit power (Pₜ) and/or the Tx beam gain (Gₜ) and the receiver 1204 may vary the Rx beam gain (Gᵣ) to keep the receive power of a given beam pair constant.

In another aspect of the present disclosure, for the receiver 1204 to constrain its Rx beam sweeping directions and/or beam gains, the receiver 1204 may be specified to obtain information related to Tx beam(s) used by the transmitter 1202. For example, information related to a Tx beam may include the transmitter 1202's transmission-reception point (TRP) position, antenna panel orientation, Tx beam direction, Tx beam gain, and/or the Tx transmit power, etc.

In one example, the transmitter 1202 may calculate and indicate the corresponding Rx beam directions and Rx beam gains paired to a Tx beam to be transmitted (or indexed) to the receiver 1204. For example, based on a Tx beam used by the transmitter 1202, the transmitter may indicate to the receiver 1204 which Rx beam direction and/or Rx beam gain is to be used for a given beam pair. Such configuration may reduce calculation and processing specified at the receiver 1204. In some examples, the indication may be based on indexes, where different indexes may be associated with different Rx beam directions/gains. As such, the transmitter 1202 may indicate an Rx beam direction/gain using a corresponding index to reduce the signaling overhead.

In another example, the transmitter 1202 may indicate the information related to a Tx beam used by the transmitter 1202 (e.g., TRP position, antenna panel orientation, Tx beam direction, Tx beam gain, Tx transmit power, etc.) to the receiver 1204. Then, the receiver 1204 may determine the corresponding Rx beam direction and/or Rx beam to pair with this Tx beam. Such configuration may enable the receiver 1204 to have more flexibilities in configuring its Rx beam(s).

In another example, sweeping plans with Tx and Rx beams paired and their related parameters (e.g., Tx power, Tx/Rx gains, etc.) may be known to both the transmitter 1202 and the receiver 1204. As such, the transmitter 1202 may inform the receiver 1204 which sweeping plan to apply, such by indicating a corresponding sweeping plan index.

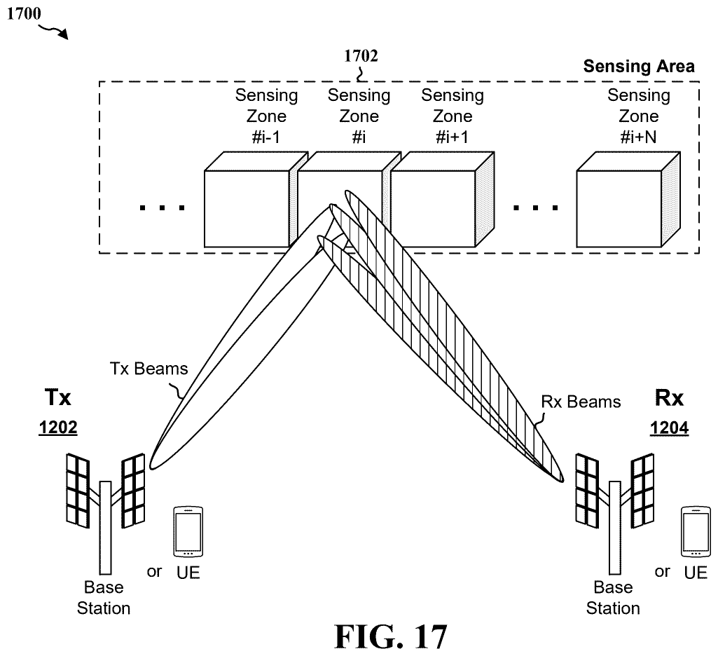

FIG. 17 is a diagram 1700 illustrating an example of a receiver constraining Rx beam directions/gains based on zones in accordance with various aspects of the present disclosure. In another aspect of the present disclosure, an area to be sensed (which may be referred to as a “sensing area”) may be divided into several zones, and the zones may be labeled by different indexes. To constrain the Rx beam directions and/or Rx beam gains, the transmitter 1202 may indicate to the receiver 1204 one or more zone indexes to perform RF sensing. Then, the transmitter 1202 and the receiver 1204 may perform the Tx and Rx beam sweeping in the corresponding zone(s). For example, as shown at 1702, the transmitter 1202 may indicate an index that correspond to a sensing zone #i to the receiver 1204, and then the transmitter 1202 and the receiver 1204 may perform Tx beam sweeping and Rx beam sweeping, respectively, within the sensing zone #i. For each zone, as directions and gains of Tx and Rx beams may be constrained by position of the zone, the power and time consumed by beam sweeping may be reduced at both the transmitter 1202 and the receiver 1204, thereby improving the efficiency of the bi-static/multi-static sensing.

In one example, the transmitter 1202 may plan/configure a Tx beam sweeping order and indicate the beam sweeping order to the receiver 1204 (e.g., for Tx-Rx-synchronization). Then, the transmitter 1202 and the receiver 1204 may perform Tx/Rx beam sweeping together on the corresponding zones based on the order. For example, the transmitter 1202 may indicate to the receiver 1204 that it will perform Tx beam sweeping for sensing zones #i to #i+N at certain time durations. Then, based on the indication, the receiver 1204 may perform Rx beam sweeping for sensing zones #i to #i+N at the same time durations. In another example, the transmitter 1202 may indicate a zone index to the receiver 1204 before sensing the corresponding zone each time (e.g., one zone is indicated to the receiver 1204 each time).

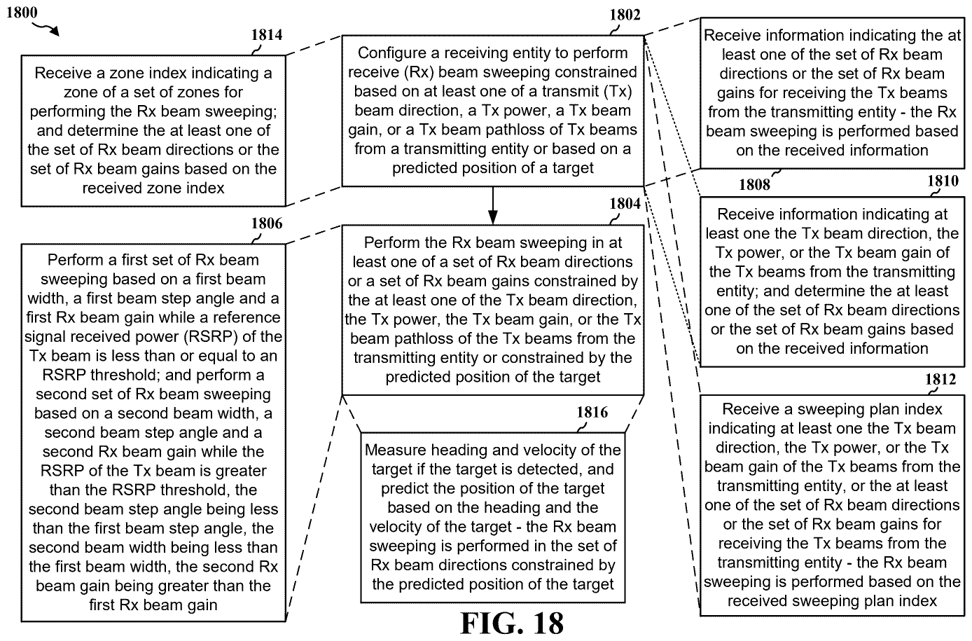

FIG. 18 is a flowchart 1800 of a method of wireless communication/RF sensing. The method may be performed by a receiving entity (e.g., the UE 104, 404; the base station 102; the receiver 1004, 1204; the apparatus 2004; the network entity 2002, 2102; the CU 2202). The method may enable the receiving entity to improve the performance and accuracy of bi-static/multi-static RF sensing by constraining its Rx beam sweeping in certain beam direction(s) and/or beam gain(s), thereby reducing the Rx beam sweeping time and power.

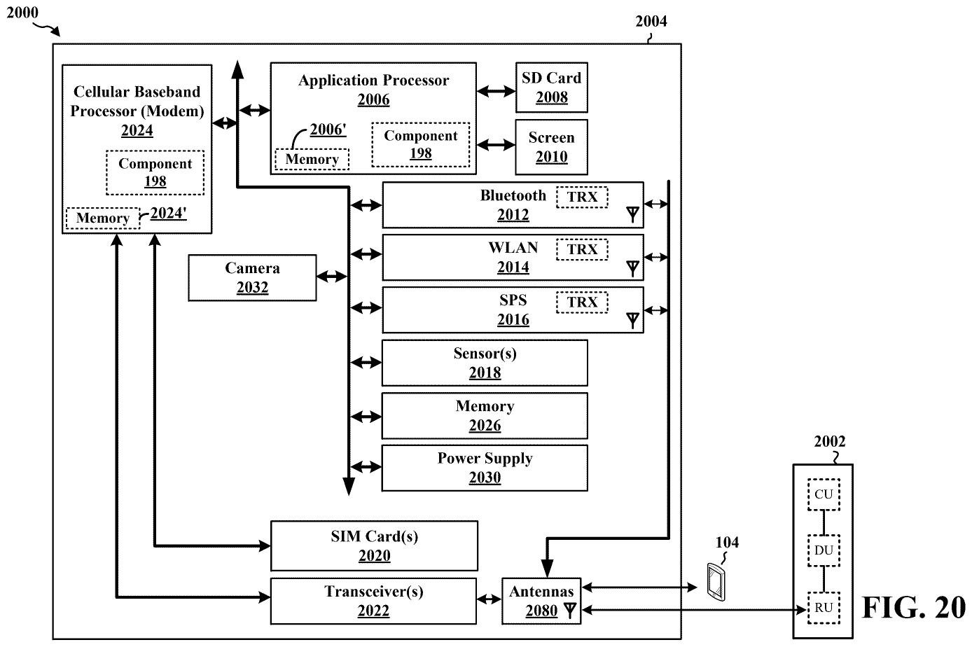

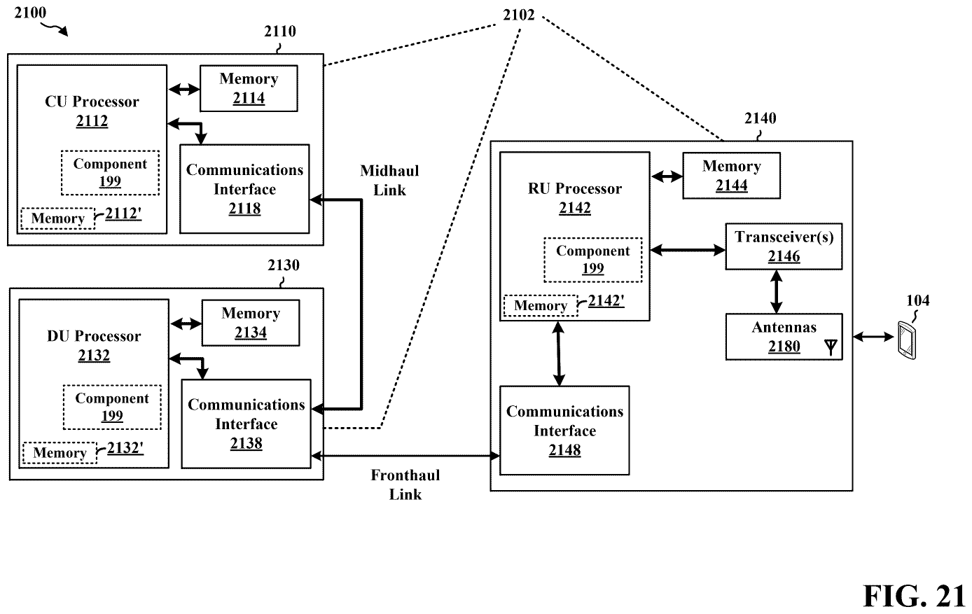

At 1802, the receiving entity may configure the receiving entity to perform Rx beam sweeping constrained based on at least one of a Tx beam direction, a Tx power, a Tx beam gain, or a Tx beam pathloss of Tx beams from a transmitting entity or based on a predicted position of a target, such as described in connection with FIGS. 12A, 12B, and 13-17. For example, as shown by the diagram 1200A of FIG. 12A, the receiver 1204 may constrain its Rx beam sweeping directions based on the maximum transmission power of a Tx beam from the transmitter 1202. As shown by the diagram 1500 of FIG. 15, the receiver 1204 may constrain its Rx beam directions based on the predicted position of the target 1504. As shown by the diagram 1600 of FIG. 16, the receiver 1204 may constrain its Rx beam gain based on the Tx beam gains/Tx power of a Tx beam from the transmitter 1202. The configuration of the Rx beam sweeping may be performed by, e.g., the beam sweep constraining configuration component 198 of the apparatus 2004 in FIG. 20 and/or the beam sweep constraining configuration component 199 of the network entity 2002/2102 in FIGS. 20 to 21.

At 1804, the receiving entity may perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target, such as described in connection with FIGS. 12A, 12B, and 13-17. For example, as shown by the diagram 1200A of FIG. 12A, the receiver 1204 may perform Rx beam sweeping with Rx beam directions constrained based on the maximum transmission power of a Tx beam from the transmitter 1202. As shown by the diagram 1500 of FIG. 15, the receiver 1204 may perform Rx beam sweeping with Rx beam directions constrained based on the predicted position of the target 1504. As shown by the diagram 1600 of FIG. 16, the receiver 1204 may perform Rx beam sweeping with Rx beam gains constrained based on the Tx beam gains/Tx power of a Tx beam from the transmitter 1202. The Rx beam sweeping may be performed by, e.g., the beam sweep constraining configuration component 198 and/or the transceiver(s) 2022 of the apparatus 2004 in FIG. 20 and/or the beam sweep constraining configuration component 199 and/or the transceiver(s) 2146 of the network entity 2002/2102 in FIGS. 20 to 21.

In one example, the Rx beam sweeping may be performed in the set of Rx beam directions constrained by the at least one of the Tx beam direction, the Tx power, or the Tx beam pathloss of the Tx beams from the transmitting entity or constrained by the predicted position of the target, and the set of Rx beam directions may include a plurality of Rx beam directions between a starting angle and a stopping angle with respect to the receiving entity, the starting angle being toward the transmitting entity, such as described in connection with FIGS. 12A and 12B. In such an example, the stopping angle may be toward a maximum transmission range of the Tx beams from the transmitting entity. In such an example, the maximum transmission range of the Tx beams from the transmitting entity may be based on the at least one of the Tx power, Tx beam gain, the Tx beam pathloss of the Tx beams, Tx antenna gain, Tx signal carrier frequency, or wireless channel coefficients from the transmitting entity.

In another example, as described in connection with FIG. 13, the stopping angle may be based on an RSRP of the Tx beams from the transmitting entity being less than an RSRP threshold.

In another example, as shown at 1806 and described in connection with FIG. 14, the receiving entity may perform a first set of Rx beam sweeping based on a first beam width, a first beam step angle and a first Rx beam gain while an RSRP of the Tx beam is less than or equal to an RSRP threshold, and the receiving entity may perform a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

In another example, as described in connection with FIG. 16, the Rx beam sweeping may be performed based on the set of Rx beam gains that is fixed. Alternatively, the Rx beam sweeping may be performed based on the set of Rx beam gains that is constrained based on the Tx beam pathloss, where each Rx beam gain in the set of Rx beam gains may be proportional to the Tx beam pathloss. In another example, the Rx beam sweeping may be performed based on the set of Rx beam gains that is further constrained based on the Tx power and Tx beam gain.

In another example, as shown at 1808, the receiving entity may receive information indicating the at least one of the set of Rx beam directions or the set of Rx beam gains for receiving the Tx beams from the transmitting entity, where the Rx beam sweeping may be performed based on the received information.

In another example, as shown at 1810, the receiving entity may receive information indicating at least one the Tx beam direction, the Tx power, or the Tx beam gain of the Tx beams from the transmitting entity, and the receiving entity may determine the at least one of the set of Rx beam directions or the set of Rx beam gains based on the received information.

In another example, as shown at 1812, the receiving entity may receive a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, where the Rx beam sweeping may be performed based on the received sweeping plan index.

In another example, as shown at 1814 and described in connection with FIG. 17, the receiving entity may receive a zone index indicating a zone of a set of zones for performing the Rx beam sweeping, and the receiving entity may determine the at least one of the set of Rx beam directions or the set of Rx beam gains based on the received zone index. Alternatively, the receiving entity may receive a set of zone indices indicating a set of zones for performing the Rx beam sweeping in a particular order for the set of zones, and the receiving entity may determine, for each zone index in the set of zone indices, the at least one of the set of Rx beam directions or the set of Rx beam gains based on the zone index, where the Rx beam sweeping may be performed in each zone of the set of zones.

In another example, as shown at 1816 and described in connection with FIG. 15, the receiving entity may measure heading and velocity of the target if the target is detected, and the receiving entity may predict the position of the target based on the heading and the velocity of the target, where the Rx beam sweeping may be performed in the set of Rx beam directions constrained by the predicted position of the target.

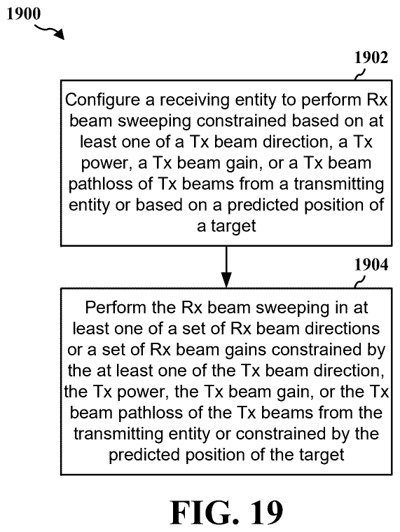

FIG. 19 is a flowchart 1900 of a method of wireless communication/RF sensing. The method may be performed by a receiving entity (e.g., the UE 104, 404; the base station 102; the receiver 1004, 1204; the apparatus 2004; the network entity 2002, 2102; the CU 2202). The method may enable the receiving entity to improve the performance and accuracy of bi-static/multi-static RF sensing by constraining its Rx beam sweeping in certain beam direction(s) and/or beam gain(s), thereby reducing the Rx beam sweeping time and power.

At 1902, the receiving entity may configure the receiving entity to perform Rx beam sweeping constrained based on at least one of a Tx beam direction, a Tx power, a Tx beam gain, or a Tx beam pathloss of Tx beams from a transmitting entity or based on a predicted position of a target, such as described in connection with FIGS. 12A, 12B, and 13-17. For example, as shown by the diagram 1200A of FIG. 12A, the receiver 1204 may constrain its Rx beam sweeping directions based on the maximum transmission power of a Tx beam from the transmitter 1202. As shown by the diagram 1500 of FIG. 15, the receiver 1204 may constrain its Rx beam directions based on the predicted position of the target 1504. As shown by the diagram 1600 of FIG. 16, the receiver 1204 may constrain its Rx beam gain based on the Tx beam gains/Tx power of a Tx beam from the transmitter 1202. The configuration of the Rx beam sweeping may be performed by, e.g., the beam sweep constraining configuration component 198 of the apparatus 2004 in FIG. 20 and/or the beam sweep constraining configuration component 199 of the network entity 2002/2102 in FIGS. 20 to 21.

At 1904, the receiving entity may perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target, such as described in connection with FIGS. 12A, 12B, and 13-17. For example, as shown by the diagram 1200A of FIG. 12A, the receiver 1204 may perform Rx beam sweeping with Rx beam directions constrained based on the maximum transmission power of a Tx beam from the transmitter 1202. As shown by the diagram 1500 of FIG. 15, the receiver 1204 may perform Rx beam sweeping with Rx beam directions constrained based on the predicted position of the target 1504. As shown by the diagram 1600 of FIG. 16, the receiver 1204 may perform Rx beam sweeping with Rx beam gains constrained based on the Tx beam gains/Tx power of a Tx beam from the transmitter 1202. The Rx beam sweeping may be performed by, e.g., the beam sweep constraining configuration component 198 and/or the transceiver(s) 2022 of the apparatus 2004 in FIG. 20 and/or the beam sweep constraining configuration component 199 and/or the transceiver(s) 2146 of the network entity 2002/2102 in FIGS. 20 to 21.

In one example, the Rx beam sweeping may be performed in the set of Rx beam directions constrained by the at least one of the Tx beam direction, the Tx power, or the Tx beam pathloss of the Tx beams from the transmitting entity, and the set of Rx beam directions may include a plurality of Rx beam directions between a starting angle and a stopping angle with respect to the receiving entity, the starting angle being toward the transmitting entity, such as described in connection with FIGS. 12A and 12B. In such an example, the stopping angle may be toward a maximum transmission range of the Tx beams from the transmitting entity. In such an example, the maximum transmission range of the Tx beams from the transmitting entity may be based on the at least one of the Tx power, Tx beam gain, the Tx beam pathloss of the Tx beams, Tx antenna gain, Tx signal carrier frequency, or wireless channel coefficients from the transmitting entity.

In another example, as described in connection with FIG. 13, the stopping angle may be based on an RSRP of the Tx beams from the transmitting entity being less than an RSRP threshold.

In another example, as described in connection with FIG. 14, the receiving entity may perform a first set of Rx beam sweeping based on a first beam width, a first beam step angle and a first Rx beam gain while an RSRP of the Tx beam is less than or equal to an RSRP threshold, and the receiving entity may perform a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

In another example, as described in connection with FIG. 16, the Rx beam sweeping may be performed based on the set of Rx beam gains that is fixed. Alternatively, the Rx beam sweeping may be performed based on the set of Rx beam gains that is constrained based on the Tx beam pathloss, where each Rx beam gain in the set of Rx beam gains may be proportional to the Tx beam pathloss. In another example, the Rx beam sweeping may be performed based on the set of Rx beam gains that is further constrained based on the Tx power and Tx beam gain.

In another example, the receiving entity may receive information indicating the at least one of the set of Rx beam directions or the set of Rx beam gains for receiving the Tx beams from the transmitting entity, where the Rx beam sweeping may be performed based on the received information.

In another example, the receiving entity may receive information indicating at least one the Tx beam direction, the Tx power, or the Tx beam gain of the Tx beams from the transmitting entity, and the receiving entity may determine the at least one of the set of Rx beam directions or the set of Rx beam gains based on the received information.

In another example, the receiving entity may receive a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, where the Rx beam sweeping may be performed based on the received sweeping plan index.

In another example, as described in connection with FIG. 17, the receiving entity may receive a zone index indicating a zone of a set of zones for performing the Rx beam sweeping, and the receiving entity may determine the at least one of the set of Rx beam directions or the set of Rx beam gains based on the received zone index. Alternatively, the receiving entity may receive a set of zone indices indicating a set of zones for performing the Rx beam sweeping in a particular order for the set of zones, and the receiving entity may determine, for each zone index in the set of zone indices, the at least one of the set of Rx beam directions or the set of Rx beam gains based on the zone index, where the Rx beam sweeping may be performed in each zone of the set of zones.

In another example, as described in connection with FIG. 15, the receiving entity may measure heading and velocity of the target if the target is detected, and the receiving entity may predict the position of the target based on the heading and the velocity of the target, where the Rx beam sweeping may be performed in the set of Rx beam directions constrained by the predicted position of the target.

FIG. 20 is a diagram 2000 illustrating an example of a hardware implementation for an apparatus 2004. the apparatus 2004 may be a UE, a component of a UE, or may implement UE functionality. In some aspects, the apparatus 2004 may include a cellular baseband processor 2024 (also referred to as a modem) coupled to one or more transceivers 2022 (e.g., cellular RF transceiver). The cellular baseband processor 2024 may include on-chip memory 2024′. In some aspects, the apparatus 2004 may further include one or more subscriber identity modules (SIM) cards 2020 and an application processor 2006 coupled to a secure digital (SD) card 2008 and a screen 2010. The application processor 2006 may include on-chip memory 2006′. In some aspects, the apparatus 2004 may further include a Bluetooth module 2012, a WLAN module 2014, an SPS module 2016 (e.g., GNSS module), one or more sensor modules 2018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2026, a power supply 2030, and/or a camera 2032. The Bluetooth module 2012, the WLAN module 2014, and the SPS module 2016 may include an on-chip transceiver (TRX) (or in some cases, just a receiver (RX)). The Bluetooth module 2012, the WLAN module 2014, and the SPS module 2016 may include their own dedicated antennas and/or utilize the antennas 2080 for communication. The cellular baseband processor 2024 communicates through the transceiver(s) 2022 via one or more antennas 2080 with the UE 104 and/or with an RU associated with a network entity 2002. The cellular baseband processor 2024 and the application processor 2006 may each include a computer-readable medium/memory 2024′, 2006′, respectively. The additional memory modules 2026 may also be considered a computer-readable medium/memory. Each computer-readable medium/memory 2024′, 2006′, additional memory modules 2026 may be non-transitory. The cellular baseband processor 2024 and the application processor 2006 are each responsible for general processing, including the execution of software stored on the computer-readable medium/memory. The software, when executed by the cellular baseband processor 2024/application processor 2006, causes the cellular baseband processor 2024/application processor 2006 to perform the various functions described supra. The computer-readable medium/memory may also be used for storing data that is manipulated by the cellular baseband processor 2024/application processor 2006 when executing software. In some examples, the cellular baseband processor 2024/application processor 2006 may be a component of the UE 350 and may include the memory 360 and/or at least one of the TX processor 368, the RX processor 356, and the controller/processor 359. In other examples, the cellular baseband processor 2024/application processor 2006 may be a component of a base station and may include the TX processor 316, the RX processor 370, and the controller/processor 375. In one configuration, the apparatus 2004 may be a processor chip (modem and/or application) and include just the cellular baseband processor 2024 and/or the application processor 2006, and in another configuration, the apparatus 2004 may be the entire UE (e.g., see 350 of FIG. 3) and include the additional modules of the apparatus 2004.

As discussed supra, the beam sweep constraining configuration component 198 is configured to configure the receiving entity to perform Rx beam sweeping constrained based on at least one of a Tx beam direction, a Tx power, a Tx beam gain, or a Tx beam pathloss of Tx beams from a transmitting entity or based on a predicted position of a target; and perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target. The beam sweep constraining configuration component 198 may be within the cellular baseband processor 2024, the application processor 2006, or both the cellular baseband processor 2024 and the application processor 2006. The beam sweep constraining configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2004 may include a variety of components configured for various functions. In one configuration, the apparatus 2004, and in particular the cellular baseband processor 2024 and/or the application processor 2006, includes means for configuring the receiving entity to perform Rx beam sweeping constrained based on at least one of a Tx beam direction, a Tx power, a Tx beam gain, or a Tx beam pathloss of Tx beams from a transmitting entity or based on a predicted position of a target; and means for performing the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

In another configuration, the Rx beam sweeping is performed in the set of Rx beam directions constrained by the at least one of the Tx beam direction, the Tx power, or the Tx beam pathloss of the Tx beams from the transmitting entity, and where the set of Rx beam directions includes a plurality of Rx beam directions between a starting angle and a stopping angle with respect to the receiving entity, the starting angle being toward the transmitting entity. In such a configuration, the stopping angle is toward a maximum transmission range of the Tx beams from the transmitting entity. In such a configuration, the maximum transmission range of the Tx beams from the transmitting entity is based on the at least one of the Tx power, Tx beam gain, the Tx beam pathloss of the Tx beams, Tx antenna gain, Tx signal carrier frequency, or wireless channel coefficients from the transmitting entity.

In another configuration, the stopping angle is based on an RSRP of the Tx beams from the transmitting entity being less than an RSRP threshold.

In another configuration, the means to perform the Rx beam sweeping further includes configuring the apparatus 2004 to perform a first set of Rx beam sweeping based on a first beam width, a first beam step angle and a first Rx beam gain while an RSRP of the Tx beam is less than or equal to an RSRP threshold; and perform a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

In another configuration, the Rx beam sweeping is performed based on the set of Rx beam gains that is fixed.

In another configuration, the Rx beam sweeping is performed based on the set of Rx beam gains that is constrained based on the Tx beam pathloss. In such a configuration, each Rx beam gain in the set of Rx beam gains is proportional to the Tx beam pathloss. Alternatively, the Rx beam sweeping is performed based on the set of Rx beam gains that is further constrained based on the Tx power and Tx beam gain.

In another configuration, the apparatus 2004 further includes means for receiving information indicating the at least one of the set of Rx beam directions or the set of Rx beam gains for receiving the Tx beams from the transmitting entity, where the Rx beam sweeping is performed based on the received information.

In another configuration, the apparatus 2004 further includes means for receiving information indicating at least one the Tx beam direction, the Tx power, or the Tx beam gain of the Tx beams from the transmitting entity.

In another configuration, the apparatus 2004 further includes means for determining the at least one of the set of Rx beam directions or the set of Rx beam gains based on the received information.

In another configuration, the apparatus 2004 further includes means for receiving a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, where the Rx beam sweeping is performed based on the received sweeping plan index.

In another configuration, the apparatus 2004 further includes means for receiving a set of zone indices indicating a set of zones for performing the Rx beam sweeping in a particular order for the set of zones.

In another configuration, the apparatus 2004 further includes means for determining, for each zone index in the set of zone indices, the at least one of the set of Rx beam directions or the set of Rx beam gains based on the zone index, where the Rx beam sweeping is performed in each zone of the set of zones.

In another configuration, the apparatus 2004 further includes means for receiving a zone index indicating a zone of a set of zones for performing the Rx beam sweeping.

In another configuration, the apparatus 2004 further includes means for determining the at least one of the set of Rx beam directions or the set of Rx beam gains based on the received zone index.

In another configuration, the Rx beam sweeping is performed to obtain bi-static sensing.

The means may be the beam sweep constraining configuration component 198 of the apparatus 2004 or configured to perform the functions recited by the means. As described supra, the apparatus 2004 may include the TX processor 368, the RX processor 356, and the controller/processor 359. As such, in one configuration, the means may be the TX processor 368, the RX processor 356, and/or the controller/processor 359 configured to perform the functions recited by the means. FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the beam sweep constraining configuration component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include a CU processor 2112. The CU processor 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include a DU processor 2132. The DU processor 2132 may include on-chip memory 2132′. In some aspects, the DU 2130 may further include additional memory modules 2134 and a communications interface 2138. The DU 2130 communicates with the RU 2140 through a fronthaul link. The RU 2140 may include an RU processor 2142. The RU processor 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the beam sweep constraining configuration component 199 is configured to configure the receiving entity to perform Rx beam sweeping constrained based on at least one of a Tx beam direction, a Tx power, a Tx beam gain, or a Tx beam pathloss of Tx beams from a transmitting entity or based on a predicted position of a target; and perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target. The beam sweep constraining configuration component 199 may be within one or more processors of one or more of the CU 2110, DU 2130, and the RU 2140. The beam sweep constraining configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2102 may include a variety of components configured for various functions. In one configuration, the network entity 2102 includes means for configuring the receiving entity to perform Rx beam sweeping constrained based on at least one of a Tx beam direction, a Tx power, a Tx beam gain, or a Tx beam pathloss of Tx beams from a transmitting entity or based on a predicted position of a target; and means for performing the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

In another configuration, the Rx beam sweeping is performed in the set of Rx beam directions constrained by the at least one of the Tx beam direction, the Tx power, or the Tx beam pathloss of the Tx beams from the transmitting entity, and where the set of Rx beam directions includes a plurality of Rx beam directions between a starting angle and a stopping angle with respect to the receiving entity, the starting angle being toward the transmitting entity. In such a configuration, the stopping angle is toward a maximum transmission range of the Tx beams from the transmitting entity. In such a configuration, the maximum transmission range of the Tx beams from the transmitting entity is based on the at least one of the Tx power, Tx beam gain, the Tx beam pathloss of the Tx beams, Tx antenna gain, Tx signal carrier frequency, or wireless channel coefficients from the transmitting entity.

In another configuration, the stopping angle is based on an RSRP of the Tx beams from the transmitting entity being less than an RSRP threshold.

In another configuration, the means to perform the Rx beam sweeping further includes configuring the network entity 2102 to perform a first set of Rx beam sweeping based on a first beam width, a first beam step angle and a first Rx beam gain while an RSRP of the Tx beam is less than or equal to an RSRP threshold; and perform a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

In another configuration, the Rx beam sweeping is performed based on the set of Rx beam gains that is fixed.

In another configuration, the Rx beam sweeping is performed based on the set of Rx beam gains that is constrained based on the Tx beam pathloss. In such a configuration, each Rx beam gain in the set of Rx beam gains is proportional to the Tx beam pathloss. Alternatively, the Rx beam sweeping is performed based on the set of Rx beam gains that is further constrained based on the Tx power and Tx beam gain.

In another configuration, the network entity 2102 further includes means for receiving information indicating the at least one of the set of Rx beam directions or the set of Rx beam gains for receiving the Tx beams from the transmitting entity, where the Rx beam sweeping is performed based on the received information.

In another configuration, the network entity 2102 further includes means for receiving information indicating at least one the Tx beam direction, the Tx power, or the Tx beam gain of the Tx beams from the transmitting entity.

In another configuration, the network entity 2102 further includes means for determining the at least one of the set of Rx beam directions or the set of Rx beam gains based on the received information.

In another configuration, the network entity 2102 further includes means for receiving a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, where the Rx beam sweeping is performed based on the received sweeping plan index.

In another configuration, the network entity 2102 further includes means for receiving a set of zone indices indicating a set of zones for performing the Rx beam sweeping in a particular order for the set of zones.

In another configuration, the network entity 2102 further includes means for determining, for each zone index in the set of zone indices, the at least one of the set of Rx beam directions or the set of Rx beam gains based on the zone index, where the Rx beam sweeping is performed in each zone of the set of zones.

In another configuration, the network entity 2102 further includes means for receiving a zone index indicating a zone of a set of zones for performing the Rx beam sweeping.

In another configuration, the network entity 2102 further includes means for determining the at least one of the set of Rx beam directions or the set of Rx beam gains based on the received zone index.

In another configuration, the Rx beam sweeping is performed to obtain bi-static sensing.

The means may be the beam sweep constraining configuration component 199 of the network entity 2102 configured to perform the functions recited by the means. As described supra, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

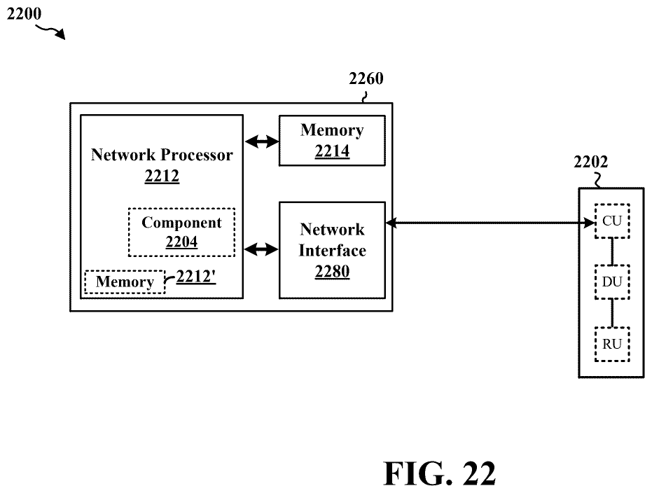

FIG. 22 is a diagram 2200 illustrating an example of a hardware implementation for a network entity 2260. In one example, the network entity 2260 may be within the core network 120. The network entity 2260 may include a network processor 2212. The network processor 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The on-chip memory 2212′ and the additional memory modules 2214 may each be considered a computer-readable medium/memory. Each computer-readable medium/memory may be non-transitory. The processor 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 2204 is configured to configure the receiving entity to perform Rx beam sweeping constrained based on at least one of a Tx beam direction, a Tx power, a Tx beam gain, or a Tx beam pathloss of Tx beams from a transmitting entity or based on a predicted position of a target; and perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target. The component 2204 may be within the processor 2212. The component 2204 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2260 may include a variety of components configured for various functions. In one configuration, the network entity 2260 includes means for configuring the receiving entity to perform Rx beam sweeping constrained based on at least one of a Tx beam direction, a Tx power, a Tx beam gain, or a Tx beam pathloss of Tx beams from a transmitting entity or based on a predicted position of a target; and means for performing the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

In another configuration, the Rx beam sweeping is performed in the set of Rx beam directions constrained by the at least one of the Tx beam direction, the Tx power, or the Tx beam pathloss of the Tx beams from the transmitting entity, and where the set of Rx beam directions includes a plurality of Rx beam directions between a starting angle and a stopping angle with respect to the receiving entity, the starting angle being toward the transmitting entity. In such a configuration, the stopping angle is toward a maximum transmission range of the Tx beams from the transmitting entity. In such a configuration, the maximum transmission range of the Tx beams from the transmitting entity is based on the at least one of the Tx power, Tx beam gain, the Tx beam pathloss of the Tx beams, Tx antenna gain, Tx signal carrier frequency, or wireless channel coefficients from the transmitting entity.

In another configuration, the stopping angle is based on an RSRP of the Tx beams from the transmitting entity being less than an RSRP threshold.

In another configuration, the means to perform the Rx beam sweeping further includes configuring the network entity 2260 to perform a first set of Rx beam sweeping based on a first beam width, a first beam step angle and a first Rx beam gain while an RSRP of the Tx beam is less than or equal to an RSRP threshold; and perform a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

In another configuration, the Rx beam sweeping is performed based on the set of Rx beam gains that is fixed.

In another configuration, the Rx beam sweeping is performed based on the set of Rx beam gains that is constrained based on the Tx beam pathloss. In such a configuration, each Rx beam gain in the set of Rx beam gains is proportional to the Tx beam pathloss. Alternatively, the Rx beam sweeping is performed based on the set of Rx beam gains that is further constrained based on the Tx power and Tx beam gain.

In another configuration, the network entity 2260 further includes means for receiving information indicating the at least one of the set of Rx beam directions or the set of Rx beam gains for receiving the Tx beams from the transmitting entity, where the Rx beam sweeping is performed based on the received information.

In another configuration, the network entity 2260 further includes means for receiving information indicating at least one the Tx beam direction, the Tx power, or the Tx beam gain of the Tx beams from the transmitting entity.

In another configuration, the network entity 2260 further includes means for determining the at least one of the set of Rx beam directions or the set of Rx beam gains based on the received information.

In another configuration, the network entity 2260 further includes means for receiving a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, where the Rx beam sweeping is performed based on the received sweeping plan index.

In another configuration, the network entity 2260 further includes means for receiving a set of zone indices indicating a set of zones for performing the Rx beam sweeping in a particular order for the set of zones.

In another configuration, the network entity 2260 further includes means for determining, for each zone index in the set of zone indices, the at least one of the set of Rx beam directions or the set of Rx beam gains based on the zone index, where the Rx beam sweeping is performed in each zone of the set of zones.

In another configuration, the network entity 2260 further includes means for receiving a zone index indicating a zone of a set of zones for performing the Rx beam sweeping.

In another configuration, the network entity 2260 further includes means for determining the at least one of the set of Rx beam directions or the set of Rx beam gains based on the received zone index.

In another configuration, the Rx beam sweeping is performed to obtain bi-static sensing.

The means may be the component 2204 of the network entity 2260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a receiving entity, including: configuring the receiving entity to perform Rx beam sweeping constrained based on at least one of a Tx beam direction, a Tx power, a Tx beam gain, or a Tx beam pathloss of Tx beams from a transmitting entity or based on a predicted position of a target; and performing the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

Aspect 2 is the method of aspect 1, where the Rx beam sweeping is performed in the set of Rx beam directions constrained by the at least one of the Tx beam direction, the Tx power, or the Tx beam pathloss of the Tx beams from the transmitting entity, and where the set of Rx beam directions includes a plurality of Rx beam directions between a starting angle and a stopping angle with respect to the receiving entity, the starting angle being toward the transmitting entity.

Aspect 3 is the method of aspect 2, where the stopping angle is toward a maximum transmission range of the Tx beams from the transmitting entity.

Aspect 4 is the method of aspect 3, where the maximum transmission range of the Tx beams from the transmitting entity is based on the at least one of the Tx power, Tx beam gain, the Tx beam pathloss of the Tx beams, Tx antenna gain, Tx signal carrier frequency, or wireless channel coefficients from the transmitting entity.

Aspect 5 is the method of aspect 2, where the stopping angle is based on an RSRP of the Tx beams from the transmitting entity being less than an RSRP threshold.

Aspect 6 is the method of any of aspects 1 to 5, where the performing the Rx beam sweeping includes: performing a first set of Rx beam sweeping based on a first beam width, a first beam step angle and a first Rx beam gain while an RSRP of the Tx beam is less than or equal to an RSRP threshold; and performing a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

Aspect 7 is the method of any of aspects 1 to 6, where the Rx beam sweeping is performed based on the set of Rx beam gains that is fixed.

Aspect 8 is the method of any of aspects 1 to 7, where the Rx beam sweeping is performed based on the set of Rx beam gains that is constrained based on the Tx beam pathloss.

Aspect 9 is the method of aspect 8, where each Rx beam gain in the set of Rx beam gains is proportional to the Tx beam pathloss.

Aspect 10 is the method of aspect 8, where the Rx beam sweeping is performed based on the set of Rx beam gains that is further constrained based on the Tx power and Tx beam gain.

Aspect 11 is the method of any of aspects 1 to 10, further including receiving information indicating the at least one of the set of Rx beam directions or the set of Rx beam gains for receiving the Tx beams from the transmitting entity, where the Rx beam sweeping is performed based on the received information.

Aspect 12 is the method of any of aspects 1 to 11, further including: receiving information indicating at least one the Tx beam direction, the Tx power, or the Tx beam gain of the Tx beams from the transmitting entity; and determining the at least one of the set of Rx beam directions or the set of Rx beam gains based on the received information.

Aspect 13 is the method of any of aspects 1 to 12, further including receiving a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, where the Rx beam sweeping is performed based on the received sweeping plan index.

Aspect 14 is the method of any of aspects 1 to 13, further including: receiving a set of zone indices indicating a set of zones for performing the Rx beam sweeping in a particular order for the set of zones; and determining, for each zone index in the set of zone indices, the at least one of the set of Rx beam directions or the set of Rx beam gains based on the zone index, where the Rx beam sweeping is performed in each zone of the set of zones.

Aspect 15 is the method of any of aspects 1 to 14, further including: receiving a zone index indicating a zone of a set of zones for performing the Rx beam sweeping; and determining the at least one of the set of Rx beam directions or the set of Rx beam gains based on the received zone index.

Aspect 16 is the method of any of aspects 1 to 15, where the Rx beam sweeping is performed to obtain bi-static sensing.

Aspect 17 is the method of any aspects 1 to 16, further including: measuring heading and velocity of the target if the target is detected; and predicting the position of the target based on the heading and the velocity of the target, where the Rx beam sweeping is performed in the set of Rx beam directions constrained by the predicted position of the target.

Aspect 18 is an apparatus for wireless communication for implementing any of aspects 1 to 17.

Aspect 19 is an apparatus for wireless communication including means for implementing any of aspects 1 to 17.

Aspect 20 is a computer-readable medium storing computer executable code, where the code when executed by a processor causes the processor to implement any of aspects 1 to 17.

What is claimed is:

1. A apparatus for wireless communication at a receiving entity, comprising:
a memory; and
at least one processor coupled to the memory and, based at least in part on information stored in the memory, the at least one processor is configured to:
configure the receiving entity to perform receive (Rx) beam sweeping constrained based on at least one of a transmit (Tx) beam direction, a Tx power, a Tx beam gain, or a Tx beam pathloss of Tx beams from a transmitting entity or based on a predicted position of a target; and
perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

2. The apparatus of claim 1, wherein the Rx beam sweeping is performed in the set of Rx beam directions constrained by the at least one of the Tx beam direction, the Tx power, or the Tx beam pathloss of the Tx beams from the transmitting entity, and wherein the set of Rx beam directions includes a plurality of Rx beam directions between a starting angle and a stopping angle with respect to the receiving entity, the starting angle being toward the transmitting entity.

3. The apparatus of claim 2, wherein the stopping angle is toward a maximum transmission range of the Tx beams from the transmitting entity.

4. The apparatus of claim 3, wherein the maximum transmission range of the Tx beams from the transmitting entity is based on the at least one of the Tx power, Tx beam gain, the Tx beam pathloss of the Tx beams, Tx antenna gain, Tx signal carrier frequency, or wireless channel coefficients from the transmitting entity.

5. The apparatus of claim 2, wherein the stopping angle is based on a reference signal received power (RSRP) of the Tx beams from the transmitting entity being less than an RSRP threshold.

6. The apparatus of claim 1, wherein to perform the Rx beam sweeping the at least one processor is further configured to:
perform a first set of Rx beam sweeping based on a first beam width, a first beam step angle and a first Rx beam gain while a reference signal received power (RSRP) of the Tx beam is less than or equal to an RSRP threshold; and
perform a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

7. The apparatus of claim 1, wherein the Rx beam sweeping is performed based on the set of Rx beam gains that is fixed.

8. The apparatus of claim 1, wherein the Rx beam sweeping is performed based on the set of Rx beam gains that is constrained based on the Tx beam pathloss.

9. The apparatus of claim 8, wherein each Rx beam gain in the set of Rx beam gains is proportional to the Tx beam pathloss.

10. The apparatus of claim 8, wherein the Rx beam sweeping is performed based on the set of Rx beam gains that is further constrained based on the Tx power and Tx beam gain.

11. The apparatus of claim 1, wherein the at least one processor is further configured to receive information indicating the at least one of the set of Rx beam directions or the set of Rx beam gains for receiving the Tx beams from the transmitting entity, wherein the Rx beam sweeping is performed based on the received information.

12. The apparatus of claim 1, wherein the at least one processor is further configured to:
receive information indicating at least one the Tx beam direction, the Tx power, or the Tx beam gain of the Tx beams from the transmitting entity; and
determine the at least one of the set of Rx beam directions or the set of Rx beam gains based on the received information.

13. The apparatus of claim 1, wherein the at least one processor is further configured to receive a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, wherein the Rx beam sweeping is performed based on the received sweeping plan index.

14. The apparatus of claim 1, wherein the at least one processor is further configured to:
receive a set of zone indices indicating a set of zones for performing the Rx beam sweeping in a particular order for the set of zones; and
determine, for each zone index in the set of zone indices, the at least one of the set of Rx beam directions or the set of Rx beam gains based on the zone index,
wherein the Rx beam sweeping is performed in each zone of the set of zones.

15. The apparatus of claim 1, wherein the at least one processor is further configured to:
receive a zone index indicating a zone of a set of zones for performing the Rx beam sweeping; and
determine the at least one of the set of Rx beam directions or the set of Rx beam gains based on the received zone index.

16. The apparatus of claim 1, wherein the at least one processor is further configured to:
measure heading and velocity of the target if the target is detected; and
predict the position of the target based on the heading and the velocity of the target,
wherein the Rx beam sweeping is performed in the set of Rx beam directions constrained by the predicted position of the target.

17. A method of wireless communication at a receiving entity, comprising:
configuring the receiving entity to perform receive (Rx) beam sweeping constrained based on at least one of a transmit (Tx) beam direction, a Tx power, a Tx beam gain, or a Tx beam pathloss of Tx beams from a transmitting entity or based on a predicted position of a target; and
performing the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

18. The method of claim 17, wherein the Rx beam sweeping is performed in the set of Rx beam directions constrained by the at least one of the Tx beam direction, the Tx power, or the Tx beam pathloss of the Tx beams from the transmitting entity, and wherein the set of Rx beam directions includes a plurality of Rx beam directions between a starting angle and a stopping angle with respect to the receiving entity, the starting angle being toward the transmitting entity.

19. The method of claim 18, wherein the stopping angle is toward a maximum transmission range of the Tx beams from the transmitting entity or based on a reference signal received power (RSRP) of the Tx beams from the transmitting entity being less than an RSRP threshold.

20. The method of claim 17, wherein the performing the Rx beam sweeping comprises:
performing a first set of Rx beam sweeping based on a first beam width, a first beam step angle and a first Rx beam gain while a reference signal received power (RSRP) of the Tx beam is less than or equal to an RSRP threshold; and
performing a second set of Rx beam sweeping based on a second beam width, a second beam step angle and a second Rx beam gain while the RSRP of the Tx beam is greater than the RSRP threshold, the second beam step angle being less than the first beam step angle, the second beam width being less than the first beam width, the second Rx beam gain being greater than the first Rx beam gain.

21. The method of claim 17, wherein the Rx beam sweeping is performed based on the set of Rx beam gains that is constrained based on the Tx beam pathloss.

22. The method of claim 21, wherein each Rx beam gain in the set of Rx beam gains is proportional to the Tx beam pathloss.

23. The method of claim 21, wherein the Rx beam sweeping is performed based on the set of Rx beam gains that is further constrained based on the Tx power and Tx beam gain.

24. The method of claim 17, further comprising receiving information indicating the at least one of the set of Rx beam directions or the set of Rx beam gains for receiving the Tx beams from the transmitting entity, wherein the Rx beam sweeping is performed based on the received information.

25. The method of claim 17, further comprising:
receiving information indicating at least one the Tx beam direction, the Tx power, or the Tx beam gain of the Tx beams from the transmitting entity; and
determining the at least one of the set of Rx beam directions or the set of Rx beam gains based on the received information.

26. The method of claim 17, further comprising receiving a sweeping plan index indicating at least one the Tx beam direction, the Tx power, or the Tx beam gain of the Tx beams from the transmitting entity, or the at least one of the set of Rx beam directions or the set of Rx beam gains for receiving the Tx beams from the transmitting entity, wherein the Rx beam sweeping is performed based on the received sweeping plan index.

27. The method of claim 17, further comprising:
receiving a set of zone indices indicating a set of zones for performing the Rx beam sweeping in a particular order for the set of zones; and
determining, for each zone index in the set of zone indices, the at least one of the set of Rx beam directions or the set of Rx beam gains based on the zone index,
wherein the Rx beam sweeping is performed in each zone of the set of zones.

28. The method of claim 17, further comprising:
receiving a zone index indicating a zone of a set of zones for performing the Rx beam sweeping; and
determining the at least one of the set of Rx beam directions or the set of Rx beam gains based on the received zone index.

29. An apparatus for wireless communication at a receiving entity, comprising:
means for configuring the receiving entity to perform receive (Rx) beam sweeping constrained based on at least one of a transmit (Tx) beam direction, a Tx power, a Tx beam gain, or a Tx beam pathloss of Tx beams from a transmitting entity or based on a predicted position of a target; and
means for performing the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.

30. A computer-readable medium storing computer executable code at a receiving entity, the code when executed by a processor causes the processor to:
configure the receiving entity to perform receive (Rx) beam sweeping constrained based on at least one of a transmit (Tx) beam direction, a Tx power, a Tx beam gain, or a Tx beam pathloss of Tx beams from a transmitting entity or based on a predicted position of a target; and
perform the Rx beam sweeping in at least one of a set of Rx beam directions or a set of Rx beam gains constrained by the at least one of the Tx beam direction, the Tx power, the Tx beam gain, or the Tx beam pathloss of the Tx beams from the transmitting entity or constrained by the predicted position of the target.
